(19) United States
(12) Patent Application Publication
(10) Pub. No.: US 2026/0360699 A1
(43) Pub. Date: Nov. 12, 2026

(54) BATTERY CELL, BATTERY APPARATUS, ELECTRICAL APPARATUS AND ENERGY STORAGE APPARATUS

(71) Applicant: CONTEMPORARY AMPEREX TECHNOLOGY CO., LIMITED, Ningde (CN)

(72) Inventors: Xinde Ye, Ningde (CN); Xiaofeng Zhang, Ningde (CN); Xiaoyang Jia, Ningde (CN); Jia Li, Ningde (FJ); Tianyue Yuan, Ningde (CN); Song Li, Ningde (CN)

(21) Appl. No.: 19/449,473

(22) Filed: Jan. 15, 2026

Related U.S. Application Data
(63) Continuation of application No. PCT/CN2025/094366, filed on May 12, 2025.

(51) Int. Cl. H01M 4/136; H01M 4/02; H01M 4/62; H01M 10/0568; H01M 10/0569; H01M 50/105

(52) U.S. Cl. CPC H01M 4/136; H01M 4/623; H01M 4/625; H01M 10/0568; H01M 10/0569; H01M 50/105; H01M 2004/021; H01M 2004/028; H01M 2220/20; H01M 2300/004

(57) ABSTRACT

The present application discloses a battery cell, a battery apparatus, an electrical apparatus, and an energy storage apparatus. The battery cell includes a stacked-type cell comprising a positive electrode plate and a negative electrode plate. The positive electrode plate includes a current collector and a positive electrode film layer on at least one side of the collector. The film layer contains lithium-containing transition metal phosphate particles, at least partially coated with carbon. The single-side thickness of the film layer (H) is 70-120 μm. A first region is defined at the bottom of the film layer adjacent to the current collector. Based on the total particle area in a cross-section along the thickness direction, 12-50% are particles with size R1≥1000 nm. In a cumulative sphericity distribution of such particles, LR1A150 is 0.6-0.8. When fully discharged, the compacted density of the positive electrode plate is 2.3-2.6 g/cm³.

### CROSS-REFERENCE TO RELATED APPLICATIONS

The present application is a continuation of International Application PCT/CN2025/094366, filed on May 12, 2025, the entire contents of which are incorporated herein by reference.

### TECHNICAL FIELD

The present application relates to the technical field of battery cells, and specifically relates to a battery cell, a battery apparatus, an electrical apparatus and an energy storage apparatus.

### BACKGROUND

In recent years, battery cells have been widely used in energy storage power systems such as hydropower, thermal power, wind power, and solar power plants, as well as in power tools, electric bicycles, electric motorcycles, electric vehicles, military equipment, aerospace and other fields.

With the double improvement of the market demand for the cruising range and safety performance of electrical apparatus, higher requirements are also put forward for the capacity and safety performance of the battery cells. However, it is difficult to achieve simultaneous improvement of the above performance in existing technology, which has become a technical problem that needs to be solved urgently in this field.

### SUMMARY OF THE INVENTION

In view of above, the present application aims to provide a battery cell with high capacity and good safety performance.

In a first aspect, the present application provides a battery cell, which includes a stacked electrode assembly, and the stacked electrode assembly includes a positive electrode plate and a negative electrode plate; the positive electrode plate includes a positive electrode current collector, and a positive electrode film layer disposed on at least one side of the positive electrode current collector; the positive electrode film layer includes lithium-containing transition metal phosphate particles; at least part of surfaces of the lithium-containing transition metal phosphate particles are provided with a carbon material; a single-side thickness of the positive electrode film layer is recorded as H, and His 70-120 μm; the positive electrode film layer includes a first region which is located at the bottom, close to the positive electrode current collector, of the positive electrode film layer; based on the total area of particles in the section along a thickness direction of the electrode plate in the first region, an area proportion of first particles with a particle size R1 meeting R1≥1000 nm is 12%-50%; in a cumulative distribution curve of sphericity area of the first particles with a particle size R1 meeting R1≥1000 nm in the section along the thickness direction of the electrode plate in the first region, a median L_{R1A1}50 of sphericity is 0.6-0.8; and when the battery cell is in a full-discharge state, a compacted density of the positive electrode plate is 2.3 g/cm³ to 2.6 g/cm³.

The gram capacity of lithium-containing transition metal phosphate materials is relatively low, and researches show that when the single-side thickness H of the positive electrode film layer is less than 70 μm, it is difficult for the battery capacity to meet market demand. The particles of the lithium-containing transition metal phosphate materials are generally nano-sized, and the applicant found that if it is needed to improve the compacted density of the film layer, it is needed to add a certain amount of first particles with a particle size R1 meeting R1≥1000 nm to the film layer. The researches show that when the area proportion of the first particles with a particle size R1 meeting R1≥1000 nm in the positive electrode film layer is less than 12% based on the total area of the particles in the section along the thickness direction of the electrode plate in the first region, the grading of the particles in the positive electrode film layer and the improvement of the compacted density will be limited, and consequently, the battery capacity cannot be effectively improved. When the battery cell is in the full-discharge state and the compacted density of the positive electrode plate is less than 2.3 g/cm³, on one hand, the battery cannot achieve high capacity, and on the other hand, it is difficult for the positive electrode film layer to achieve effective particle connection, which influences the conduction smoothness of electron and ion and increases the battery impedance. When the area proportion of the first particles with a particle size R1 meeting R1≥1000 nm in the positive electrode film layer is greater than 50% based on the total area of the particles in the section along the thickness direction of the electrode plate in the first region, or the compacted density of the positive electrode plate of the battery cell in the full-discharge state is greater than 2.6 g/cm³, or in the cumulative distribution curve of sphericity area of the first particles in the section along the thickness direction of the electrode plate in the first region, the median L_{R1A1}50 of sphericity is 0.6, a thick-coated film layer is prone to stress concentration on large particles during die cutting of the electrode plate, which causes obvious leakage of current collectors after die cutting of the electrode plate.

According to the embodiment of the present application, the battery capacity is improved by the stacked electrode assembly in cooperation with the thick-coated lithium-containing transition metal phosphate positive electrode film layer. Moreover, by reducing the content of large-particle lithium-containing transition metal phosphate close to the current collector in the positive electrode film layer, increasing the sphericity of the large-particle lithium-containing transition metal phosphate and reducing the compacted density of the positive electrode film layer, the stress concentration between the positive electrode film layer and the current collector is relieved, the phenomenon that the film layer of the stacked electrode assembly is loosened and even falls off in the die cutting process is relieved, and thus potential safety hazard is reduced.

In any embodiment, the single-side thickness of the positive electrode film layer is recorded as H, and His 90-120 μm.

The single-side thickness of the positive electrode film layer is within the above range, which is conducive to further improving the battery capacity.

In any embodiment, the single-side thickness of the positive electrode film layer is recorded as H, and His 100-120 μm.

The battery capacity can be further improved by further increasing the single-side thickness of the positive electrode film layer, but the applicant found that when the single-side thickness of the positive electrode film layer was greater than or equal to 100 μm, the phenomenon of current collector exposed from the positive electrode plate was more serious; according to the embodiment of the present application, by reducing the content of large-particle lithium-containing transition metal phosphate close to the current collector in the positive electrode film layer, increasing the sphericity of the large-particle lithium-containing transition metal phosphate and reducing the compacted density of the positive electrode film layer, the stress concentration between the positive electrode film layer and the current collector can be relieved, the phenomenon that the thick-coated film layer in the positive electrode plate is loosened and even falls off in the die cutting process is greatly reduced, and thus the potential safety hazard is reduced on the basis of keeping relatively high capacity of the battery.

In any embodiment, the positive electrode film layer also includes a conductive agent; and based on the total area of the section of the positive electrode plate along the thickness direction of the positive electrode film layer, the total area of an agglomeration region of the conductive agent accounts for 0.2%-6%, optionally, 1.5%-5%.

Based on the total area of the section of the positive electrode film layer along the thickness direction of the electrode plate, the area proportion of the agglomeration region of the conductive agent is within the above range, which indicates that the conductive agent in the positive electrode film layer is uniformly dispersed and easy to form a uniform conductive network, it is particularly conducive to reducing the problem of dynamics reduction of the thick-coated film layer caused by the increase in an ion transmission path, and reducing the problems of local polarization and even lithium precipitation of the battery in the cycle process.

Moreover, the researches show that large-size first particles in the lithium-containing transition metal phosphate are easy to rebound, the agglomeration area of the conductive agent is within the above range, thus the rebound of the lithium-containing transition metal phosphate particles can be inhibited by means of the uniform distribution of the conductive agent, mechanical constraint can be performed on the particles and even the film layer, thereby improving the cohesion of the film layer, reducing the phenomena of powder falling and falling of the film layer, as well as prolonging the cycle life of the battery.

In any embodiment, the conductive agent includes carbon nanotubes which include one or more of a single-walled carbon nanotube, a few-walled carbon nanotube and a multi-walled carbon nanotube, optionally, the conductive agent also includes conductive carbon black.

The carbon nanotubes have a high length-diameter ratio, which is conducive to overlapping a plurality of positive electrode particles and the particles in the thickness direction to form a long-range conductive path and improve the constraint force among the particles at the same time, thereby improving the dynamics performance of the thick-coated positive electrode film layer, reducing the problems of local polarization and even lithium precipitation of the battery in the cycle process, and prolonging the cycle life of the battery; and moreover, by the constraint effect, the rebound phenomena of the large particles in the thick-coated film layer and a thick film layer can be reduced, and the phenomenon of falling of the film layer is reduced.

The conductive carbon black has a small size, and is attached to the surfaces of the positive electrode particles and filled among gaps of the positive electrode particles to realize dense point-shaped conductive contact. The conductive carbon black and the positive electrode particles are used in match to realize long-distance conduction and short-distance conduction, which is conducive to further perfecting the conductive network in the positive electrode film layer. Moreover, the conductive agent has a large specific surface area, which facilitates liquid absorption and liquid retention, and reduces a phenomenon of electrolyte solution extrusion caused by high expansion force increase amplitude of the thick-coated electrode plate in a long cycle process, thereby prolonging the long cycle life of the battery.

In any embodiment, the agglomeration region of the conductive agent includes carbon nanotubes and conductive carbon black.

Researchers found that the carbon nanotubes are prone to agglomeration due to high surface energy, resulting in uneven dispersion in the positive electrode film layer, and inability to form an effective carbon nanotube network structure. The surface energy of the conductive carbon black is close to that of the carbon nanotubes, so the conductive carbon black can be adsorbed on the surfaces of the carbon nanotubes to form a physical barrier, which increases the agglomeration resistance of the carbon nanotubes, reduces direct contact among the carbon nanotubes, thus inhibiting the agglomeration phenomenon, and improving the distribution uniformity of the carbon nanotubes in the positive electrode film layer. On one hand, it is conducive to improving the conductivity of the thick-coated positive electrode film layer, thus improving the dynamics performance of the battery; and on the other hand, the constraint effect of the carbon nanotubes on the positive electrode film layer is exerted, thus reducing the risk that the thick-coated positive electrode film layer falls off, and further improving the dynamics performance of the battery and prolonging the cycle life of the battery. In addition, the agglomeration of the carbon nanotubes in the agglomeration region of the conductive agent may cause blockage of the local ion transmission path of the agglomeration region of the conductive agent, and the conductive carbon black is matched to use, which can improve the lithium ion transmission capacity in this region, reduce local polarization, thereby further improving the cycle stability of the battery.

In any embodiment, based on a mass of the positive electrode film layer, a mass content C1 of the carbon nanotubes meets: 0<C1≤2.5%, and a mass content C2 of the conductive carbon black meets: 0<C2≤2.5%.

The mass content of the carbon nanotubes and the conductive carbon black is within the above range, so that the agglomeration phenomenon of the carbon nanotubes can be effectively relieved and a good conductive network structure can be formed, thereby effectively relieving the stress concentration of the positive electrode film layer, improving the liquid retention rate of the positive electrode film layer in the long cycle process, further reducing the falling risk and the polarization degree of the electrode plate film layer, improving the dynamics performance of the battery, as well as prolonging the cycle life of the battery.

In any embodiment, the positive electrode film layer also includes a dispersant which includes hydrogenated nitrile butadiene rubber (HNBR).

Polar groups (such as cyano groups, —CN) in HNBR molecules can interact with hydroxyl group (—OH) or metal oxide sites on the surfaces of the lithium-containing transition metal phosphate particles (such as hydrogen bonds, and dipole-dipole interaction), which enhances the compatibility of the particles and a solvent, and reduces the interfacial tension of the particles and the solvent, especially the interfacial tension of the large particles, thus the particles are easier to disperse uniformly, the aggregation caused by hydrophobicity can be reduced, the dispersibility of the large particles in the positive electrode film layer can be improved, and the stress concentration in the die cutting process of the thick-coated film layer can be reduced.

Moreover, when slurry is dried to form a film, an elastic network structure of the HNBR can buffer shrinkage stress generated by solvent volatilization, thus the re-aggregation of the conductive agent due to capillary force in this process can be reduced, the area proportion of the aggregation region of the conductive agent is reduced, and the cycle life of the battery is prolonged.

In any embodiment, the mass content of the dispersant is 0.5%-2% based on the mass of the positive electrode film layer.

The mass content of the dispersant is within the above range, so that uniform dispersion of the large particles in the positive electrode film layer can be achieved when the positive electrode film layer is kept to have a high-content positive electrode active material, the stress concentration caused by local particle accumulation can be reduced, the phenomenon that the film layer of the stacked electrode assembly is loosened and even falls off in the die cutting process is relieved and the potential safety hazard is reduced.

In any embodiment, the lithium-containing transition metal phosphate particles in the positive electrode film layer include components shown in the following general formula: LiₘFeₓP_{y}OⱼQ_{q} (Formula I), in which, Q includes one or more of Al, Na, K, Mg, Cu, Mn, Cr, Zn, Pb, Ca, Co, Ni, Sr, Nb, V, Ti, B, S, Si, N, F, Cl, and Br, 0.8≤m≤1.15, 0.9≤x≤1, 0.95≤y≤1, 3.5≤j≤4, 0≤q≤0.1.

In any embodiment, the lithium-containing transition metal phosphate particles include a titanium element; and based on the total mass of the lithium-containing transition metal phosphate particles in the positive electrode film layer, the mass content of the titanium element is 500-8,000 ppm, optionally, 1,000-3,000 ppm.

When the titanium element is doped into the lithium-containing transition metal phosphate particles, a formed Ti—O—P bond has a strong binding effect; by anchoring a phosphate group, the shrinkage/expansion amplitude of a crystal lattice in lithium ion de-intercalation can be reduced, thus the structural stress caused by phase change is inhibited, and the cycle life of the battery can be prolonged; and furthermore, the Ti—O—P bond can provide a more stable channel for lithium ion diffusion, which reduces a migration energy barrier, and is conducive to improving the dynamics performance of the battery.

The mass content of the titanium element is within the above range, which is conducive to increasing the lithium ion transmission rate of the positive electrode active material, relieving the problems of long ion diffusion path and poor dynamics caused by the thick-coated electrode plate and the positive electrode film layer containing a certain amount of first particles, thereby reducing the lithium precipitation risk, and improving the dynamics performance of the battery.

In any embodiment, the lithium-containing transition metal phosphate particles include a vanadium element; and based on the total mass of the lithium-containing transition metal phosphate particles in the positive electrode film layer, the mass content of the vanadium element is 500-5,000 ppm, optionally, 500-3,000 ppm.

When the vanadium element is doped into the lithium-containing transition metal phosphate particles, a multi-valence characteristic is realized; when +5-valent vanadium (V⁵⁺) is doped into a phosphorus site, the radius increases, which leads to lattice distortion, then the lithium ion diffusion channel is expanded, and the ionic conductivity of the positive electrode active material is improved; and when +3-valent vanadium (V³⁺) is doped into a transition metal site, charges are compensated by a lithium vacancy or interstitial oxygen, a defect level is formed, and thus the electronic conductivity of the positive electrode active material is improved.

The mass content of the vanadium element is within above range, which is conducive to increasing the lithium ion transmission rate of the positive electrode active material, improving the electronic conductivity of the positive electrode active material, and further improving the dynamics performance of the battery in cooperation with the doped titanium element.

In any embodiment, the battery cell also includes a separator arranged between the positive electrode plate and the negative electrode plate; the separator includes a base film, ceramic layers disposed on two sides of the base film, and a binding layer which is disposed on the side, far away from the base film, of the ceramic layer on at least one side; and the binding layer is a continuous layer of a porous structure and includes a vinylidene fluoride polymer.

According to the separator provided by the embodiment of the present application, the continuous layer of the porous structure is treated as the binding layer, which has a larger binding area than an island-shaped binding layer in related technology, thus the separator and the positive electrode film layer can be bonded firmer and more uniform; moreover, by means of the porous structure in the binding layer, the transmission efficiency of lithium ions, as well as the dynamics performance of the battery can be achieved at the same time. Moreover, compared with a wound cell, the stacked electrode assembly has the advantages that the compression force between the electrode plates is small in the cell preparation process, and the lithium-containing transition metal phosphate of the first particles with a particle size R1 meeting R1≥1000 nm can reduce the compact degree of internal components of a cell in the rebounding process, thereby improving the impedance of the cell and increasing the probability of powder falling and even falling of the film layer. According to the separator provided by the embodiment of the present application, the continuous layer of the porous structure is treated as the binding layer, it is particularly suitable for a thick-coated stacked electrode assembly, it can relieve the rebound phenomenon of the thick-coated stacked electrode assembly in the long cycle process, and improve the maintenance of the battery capacity in the long cycle process. In addition, the thick-coated stacked electrode assembly is prone to relative displacement between the electrode plate and the separator in the process of dragging an outer electrode plate and welding a tab, which easily causes powder falling of the film layer, even causes mutual overlapping of a positive electrode and a negative electrode, resulting in a risk of internal short circuit.

According to the embodiment of the present application, the continuous layer of the porous structure is treated as the binding layer, which keeps the air permeability and the porosity of the separator while improving the binding force between the separator and the electrode plate, improves the stability of the thick-coated film layer electrode plate, further reduces the risk of powder falling and even internal short circuit caused by relative displacement between the electrode plate and the separator, and improving the cycle stability of the battery.

In any embodiment, the battery cell includes an electrolyte which includes a solvent; and the solvent includes one or two of Ethyl Methyl Carbonate (EMC) and Ethylene Carbonate (EC), and dimethyl carbonate (DMC).

The DMC has relatively good solubility on lithium hexafluorophosphate; an electrolyte solution can provide enough lithium ion concentration, so that necessary ion conduction conditions are provided for a charge-discharge process of a lithium-containing transition metal phosphate battery. Moreover, the DMC is low in viscosity, thus the moving rate of lithium ions can be increased, the fast charge performance of the battery can be improved, and the disadvantage that the long ion diffusion path of the thick-coated electrode plate and the positive electrode film layer containing a certain amount of first particles leads to reduction of dynamics performance is improved.

In any embodiment, the mass proportion of the DMC is 18%-32% based on the total mass of the electrolyte.

The mass proportion of the DMC is within the above range, so that the cycle life of the battery is prolonged while the battery has good fast charge performance.

In any embodiment, the total mass proportion of the EMC to the EC is 52%-71% based on the total mass of the electrolyte.

In any embodiment, the electrolyte includes an electrolyte salt which includes lithium hexafluorophosphate (LiPF₆), and the concentration of the lithium hexafluorophosphate in the electrolyte is 0.9-1.2 mol/L.

In any embodiment, based on the total area of the particles in the section along the thickness direction of the electrode plate in the first region, the area proportion of the particles with a particle size R1 meeting 1 μm≤R1≤5 μm is 12%-40%.

The area proportion of the particles with a particle size R1 meeting 1 μm≤R1≤5 μm in the first region is within above range, which is conducive to further reliving stress concentration between the positive electrode film layer and the current collector on the basis of keeping high capacity of the battery, relieving the phenomenon that the film layer of the stacked electrode assembly is loosened and even falls off in the die cutting process, thereby reducing the potential safety hazard.

In any embodiment, in the cumulative distribution curve of sphericity area of the particles with the particle size R1 meeting 1 μm≤R1≤5 μm in the section along the thickness direction of the electrode plate in the first region, the median L_{R1A2}50 of sphericity is 0.65-0.75.

In the cumulative distribution curve of sphericity area of the first particles in the section along the thickness direction of the electrode plate in the first region close to the current collector, the median of sphericity is within the above range, which is conducive to further reducing the stress concentration caused in the cutting process of the thick-coated film layer.

In any embodiment, in the cumulative distribution curve of sphericity area of the particles with the particle size R1 meeting 1 μm≤R1≤5 μm in the section along the thickness direction of the electrode plate in the first region, the median L_{R1A2}50 of sphericity is 0.67-0.75.

The median L_{R1A2}50 of sphericity of the particles with a particle size R1 meeting 1 μm≤R1≤5 μm in the first region is within above range, so that the stress concentration between the positive electrode film layer and the current collector can be further relieved, and the cycle life of the battery cell is prolonged.

In any embodiments, in a cumulative distribution curve of C value of degree of graphitization of the positive electrode film layer obtained in a surface scanning mode of a laser microscopic confocal Raman spectrometer, the median C₅₀ of the degree of graphitization is greater than or equal to 0.95 and less than or equal to 1.20, in which, the C value of the degree of graphitization is I_{G}/I_{D}, I_{G} indicates an intensity of a G band of a Raman spectrum at 1580±100 cm⁻¹, and Ip indicates the intensity of a D band of the Raman spectrum at 1350±100 cm⁻¹.

In the cumulative distribution curve of C value of degree of graphitization of the positive electrode film layer obtained in the surface scanning mode of the laser microscopic confocal Raman spectrometer, the median C50 of the degree of graphitization is within above range, so that the compacted density of the electrode plate can be further improved, the content of first particles in the positive electrode film layer and the thickness of the positive electrode film layer can be reduced, which is conducive to further reducing the demolding probability of the positive electrode film layer on the basis of keeping the energy density of the battery.

In any embodiment, the porosity of the positive electrode film layer is 14%-28%.

The porosity of the positive electrode film layer is within the above range, which is conducive to improving the liquid retention characteristic of electrolyte solution, improving the ion diffusivity of the thick-coated electrode plate and the positive electrode film layer containing a certain amount of first particles, thereby improving the dynamics performance of the battery.

In any embodiment, a primer is arranged in a bottom region, close to the positive electrode current collector, of the positive electrode film layer and includes a conductive agent and a binder, in which, the conductive agent includes carbon nanotubes and conductive carbon black, and the binder includes a vinylidene fluoride polymer.

In any embodiment, the primer is arranged in the bottom region, close to the positive electrode current collector, of the positive electrode film layer and has a thickness of 0.5-5 μm.

According to the embodiment of the present application, with adoption of the primer, the particle size of particles at a part in direct contact with the current collector can be reduced, thus the stress concentration of the current collector at a die cutting position is reduced, the extrusion effect of the first particles in the positive electrode film layer on the current collector in the die cutting process is reduced, and the risk of aluminum leakage of the thick-coated electrode plate in the die cutting process is reduced; and moreover, the impedance of the thick-coated electrode plate is reduced, and the dynamics performance of the battery is improved.

In any embodiment, the battery cell includes a case in which the stacked electrode assembly is accommodated; and the size of the case in a length direction is L0, the size of the case in a width direction is W0, the size of the case in a thickness direction is H0, and 450 mm≤L0≤1300 mm, 100 mm≤W0≤150 mm, 14 mm≤H0≤22 mm.

According to the embodiment of the present invention, the size of the case of the battery cell is within the above range, which facilitates the battery to achieve relatively good capacity.

In any embodiment, the size L0 of the case in the length direction meets: 450 mm≤L0≤650 mm.

When the size L0 of the case in the length direction meets: 450 mm≤L0≤650 mm, the battery cell has a relatively short length, which is conducive to shortening the electron transmission path, reducing the internal resistance of the battery, shortening an infiltration distance of the electrolyte solution in an electrode pore, improving the infiltration uniformity, and improving the dynamics performance of the thick-coated electrode plate; and particularly, the phenomena of uneven temperature rise and uneven current density in the length direction of the electrode plate can be reduced under a fast charge condition.

In any embodiment, the size L0 of the case in the length direction meets: 900 mm≤L0≤1300 mm.

When the size L0 of the case in the length direction meets: 900 mm≤L0≤1300 mm, a traditional module structure can be effectively simplified by the greatly increased cell size, and the battery cell can be directly integrated into a battery pack; the battery is fixed by a structural member arranged at the end part of a large surface, thus the space utilization rate is significantly improved, furthermore, the overall capacity of a battery system is increased under the same volume; and moreover, the quantity of the structural members is reduced, and the energy density of the battery is improved.

In any embodiment, the material of the case is a pouch material which includes an aluminum-plastic composite film, optionally, a composite film formed by one or more of Polypropylene (PP), Polybutylene terephthalate (PBT), Polybutylene succinate (PBS), nylon, Polyethylene terephthalate (PET) and Polyethylene (PE), and aluminum.

Compared with hard case materials such as an aluminum case and a steel case, the pouch material is light in weight, which is conducive to improving the energy density of the lithium-containing transition metal phosphate battery, thereby improving the capacity of the battery cell.

In any embodiment, the case includes a first sealing region which is disposed on at least one end, extending along the width direction, of the stacked electrode assembly; the first sealing region includes an edge folding structure extending along the length direction; and a package adhesive is disposed on the edge folding structure, is continuously arranged along the length direction and is used for fixing the edge folding structure.

According to the embodiment of the present application, the sealing strength of the first sealing region is further improved by the edge folding structure extending along the length direction in the first sealing region. The package adhesive is continuously arranged along the length direction and is used for fixing the edge folding structure, which further improves the package strength compared with discontinuous arrangement of the package adhesive along the length direction, thus continuous reinforcement along the length direction of the sealing region is achieved, and the probability that the thick-coated pole plate breaks through the sealing region in a package during the cycle process is reduced.

In any embodiment, the case includes at least one second sealing region which is disposed on at least one end, extending along the length direction of the case, of the stacked electrode assembly; and the second sealing region is disposed on a tab side of the stacked electrode assembly.

The second sealing region is disposed on the tab side of the stacked electrode assembly, the tab is needed to be connected to a lead-out member, the connection strength of the lead-out member and the case material is relatively weak, so gas is easy to rush out from the joint to result in a weak point easy to relieve pressure, which is conducive to directional pressure relief of the battery, thus reducing the influence on an adjacent cell during thermal runaway, and prolonging the service life of the whole battery.

In any embodiment, a plurality of rubber rings surrounding along the width direction are arranged at the periphery of the stacked electrode assembly and are arranged at intervals along the length direction.

The rubber rings surrounding along the width direction of the cell are arranged at intervals in the length direction, which is conducive to fixing the position of electrode plates in the cell, and reducing the probability of displacement of the cell in the shaking process of the battery; it is particularly suitable for batteries with a relatively large length, the phenomenon of lithium precipitation caused by mutual displacement of the electrode plates in the length direction can be effectively reduced, and the stability of a space structure in the battery is favorably kept, so that the normal operation of the battery is not influenced.

In any embodiment, at 25 °C, the capacity of the battery cell is 100-300 Ah, optionally, 110-190 Ah, further optionally, 125-180 Ah.

According to the battery cell provided by the embodiment of the present application, the stacked electrode assembly is accommodated in the care with a proper size, a reasonable large particle proportion in the film layer of the positive electrode plate in the stacked electrode assembly is controlled, so that the battery cell has relatively high capacity.

In a second aspect, the present application provides a battery apparatus, which includes the battery cell provided by the present application in the first aspect.

In a third aspect, the present application provides an electrical apparatus which includes the battery apparatus provided in the second aspect, and the battery apparatus is configured to provide electric energy.

In a fourth aspect, the present application provides an energy storage apparatus which includes the battery apparatus provided in the second aspect, and the battery apparatus is configured to store electric energy.

### BRIEF DESCRIPTION OF THE DRAWINGS

FIG. 1 is a schematic diagram of a positive electrode plate in an embodiment of the present application;

FIG. 2(a), FIG. 2(b), and FIG. 2(c) are each a scanning electron micrograph of a section of a positive electrode plate along a thickness direction under different amplification factors in an embodiment of the present application; FIG. 2(d) is an area analysis diagram of an agglomeration region of a conductive agent in a scanning electron micrograph of a section of a positive electrode plate along a thickness direction in an embodiment of the present application;

FIG. 3(a) is a schematic diagram of a separator in an embodiment of the present application; FIG. 3(b) is a schematic diagram of a separator in an embodiment of the present application; FIG. 3(c) is a schematic diagram of a surface appearance of a binding layer of a separator in an embodiment of the present application;

FIG. 4 is a front view of a battery cell in an embodiment of the present application; and

FIG. 5 is a schematic diagram of an electrical apparatus in an embodiment of the present application.

### REFERENCE NUMERALS

5, battery cell; 50, case; 51, first sealing region; 52, second sealing area; 53, lead-out member; 10, positive electrode plate; 101, positive electrode current collector; 102, positive electrode film layer; 102a, first surface; 102b, second surface; 1021, first region; 20, separator; 201, base film; 202, ceramic layer; 203, binding layer; X, length direction; Y, width direction; and Z, thickness direction.

### DETAILED DESCRIPTION

Embodiments of a battery cell, a battery apparatus, an electrical apparatus and an energy storage apparatus of the present application are specifically disclosed with appropriate reference to the attached accompanying drawings. However, there are cases where unnecessary details are omitted. For example, there are cases where detailed descriptions of well-known items and repeated descriptions of actually identical structures are omitted. This is to avoid unnecessary redundancy in the following descriptions and to facilitate understanding by those skilled in the art. In addition, the accompanying drawings and subsequent descriptions are provided for those skilled in the art to fully understand the present application, and are not intended to limit the subject matter recited in the claims.

The “ranges” disclosed in the present application are defined in the form of lower and upper limits. A given range is defined by selecting a lower limit and an upper limit, and the selected lower and upper limits define the boundaries of the particular range. The range defined in this way may include or may not include end values, and may be arbitrarily combined, that is, any lower limit can be combined with any upper limit to form a range. For example, if the ranges 60-120 and 80-110 are listed for specific parameters, it is understood that the ranges 60-110 and 80-120 are also expected. In addition, if the listed minimum range values are 1 and 2 and if the listed maximum range values are 3, 4, and 5, the following ranges can all be expected: 1-3, 1-4, 1-5, 2-3, 2-4, and 2-5. In the present application, unless otherwise specified, the numerical range “a-b” represents an abbreviated representation of any combination of real numbers between a and b, wherein a and b are both real numbers. For example, the numerical range “0-5” indicates that all real numbers between “0-5” have been listed herein, and “0-5” is only a shortened representation of these numerical combinations. In addition, when a parameter is expressed as an integer greater than or equal to 2, it is equivalent to disclosing that the parameter is, for example, an integer of 2, 3, 4, 5, 6, 7, 8, 9, 10, 11, 12, and the like.

Unless otherwise specifically stated, all embodiments and optional embodiments of the present application may be combined with each other to form new technical solutions, and such technical solutions should be considered as being included in the disclosure of the present application.

Unless otherwise specifically stated, all technical features and optional technical features of the present application may be combined with each other to form new technical solutions, and such technical solutions should be considered as being included in the disclosure of the present application.

Unless otherwise specified, all steps in the present application can be carried out sequentially or randomly, preferably sequentially. For example, the method includes steps (a) and (b), indicating that the method may include steps (a) and (b) in sequence, and may also include steps (b) and (a) in sequence. For example, the method may include a step (c), indicating that step (c) may be added to the method in any order, for example, the method may include steps (a), (b) and (c), may also include steps (a), (c) and (b), and may also include steps (c), (a) and (b) and the like.

In the present application, the terms “a plurality of”, and “various” refer to two or more than two.

Unless otherwise stated, the terms used in the present application have the well-known meanings commonly understood by those skilled in the art.

Unless otherwise stated, numerical values of parameters mentioned in the present application may be measured using various testing methods commonly used in the art. For example, the numerical values may be measured according to testing methods given in the embodiments of the present application. Unless otherwise specified, the test temperature for each parameter is 25 °C.

In the embodiment of the present application, the battery apparatus can include one or more battery cell assemblies for providing voltage and capacity. The battery cell assembly can include a plurality of pouch battery cells which are connected in series, in parallel or in series-parallel connection by a bus part. For example, the battery cell assembly is generally formed by arranging a plurality of pouch battery cells; the battery cell assembly may be a battery module, and the battery module is formed by arranging and fixing a plurality of pouch battery cells to form an independent module. As an example, the battery module may be formed by binding a plurality of battery cells with a binding tape.

The battery apparatus can be a battery pack which includes a box body and one or more battery cell assemblies, and the battery cell assembly is accommodated in the box body. The battery cell assembly may be the battery module, and the battery cell assembly can be accommodated in the box body in a manner of fixing the battery module in the box body; and the battery cell assembly can also be accommodated in the box body in a manner of directly fixing the plurality of pouch battery cells in the box body.

In the embodiment of the present application, the box body can include a first box body and a second box body. The first box body and the second box body are buckled to form an enclosure space in the box body to accommodate the battery cell assembly. Enclosure here means covering or closing, and may be sealed or unsealed. The first box body can be a top cover or a bottom plate. For example, the box body can include a top cover, a frame and a bottom plate. The top cover and the bottom plate are respectively connected to the frame, so that the enclosure space is formed in the box body to accommodate the battery cell assembly.

In the embodiment of the present application, the box body can be used as a part of a chassis structure of a vehicle. For example, part of the box body can be treated as at least a part of a floor of the vehicle, or, the part of the box body can be treated as at least a part of a cross beam and a longitudinal beam of the vehicle.

In the embodiment of the present application, the battery cell may be a secondary battery, and the secondary battery refers to the battery cell which can be continuously used by activating an active material in a charging mode after the battery cell is discharged; and the battery cell may be a lithium-ion battery. The battery cell can be flat.

The battery provided by the embodiment of the present application can be a single physical module including one or more battery cells for providing higher voltage and capacity. For example, the battery mentioned in the present application may include a battery cell, a battery module, a battery pack, or the like.

The battery cell is the smallest cell that forms the battery, and it can independently charge and discharge electricity. When there are a plurality of battery cells, the plurality of battery cells are connected in series, in parallel or in series-parallel through a bus component. In some embodiments, the battery can be a battery module, and when a plurality of battery cells are provided, the plurality of battery cells are arranged and fixed to form a battery module. In some embodiments, the battery may be a battery pack, the battery pack includes the box body and the battery cell, and the battery cell or the battery module is accommodated in the box body. In some embodiments, the box body can be treated as a part of a chassis structure of a vehicle. For example, part of the box body can be treated as at least one part of a bottom plate of the vehicle, or, part of the box body ca be treated as at least one part of a cross beam and a longitudinal beam of the vehicle.

In some embodiments, the battery can be an energy storage apparatus. The energy storage apparatus includes an energy storage container, an energy storage electric cabinet and the like.

In some embodiments, the battery can be assembled into thee battery module, a plurality of battery cells can be in the battery module, and the specific number can be adjusted according to the application and capacity of the battery module. In some embodiments, the battery modules can also be assembled into a battery pack, and the number of the battery modules in the battery can be selected according to the application and the capacity of the battery pack.

The battery cell includes an electrode assembly and an electrolyte.

The electrode assembly usually includes a positive electrode plate and a negative electrode plate, in which, the negative electrode plate is an electrode that occurs the reaction of absorbing or liturifying lithium ions during charging, and releasing or delithiating lithium during discharging, and the positive electrode plate is an electrode that occurs the reaction of releasing or delithiating lithium ions during charging, and absorbing or lithiating lithium during discharging.

Lithium-containing transition metal phosphate materials have the advantages of high safety, long cycle life, low cost, and stable high-temperature performance, but the gram capacity of lithium-containing transition metal phosphate materials is low, which is not conducive to the improvement of battery capacity. In order to overcome the above shortcomings of the materials, the applicant found that it is needed to perform thick-coating in the design of the electrode plates to increase the load of the positive electrode active material in the battery, so as to improve the energy density of the battery cell. A thick-coated positive electrode film layer is prone to stress concentration in a corner region of a wound cell, resulting in powder falling off or even falling off of the film layer, in addition, due to the corner region of the wound cell, its group margin is reduced compared with that of a stacked electrode assembly, which is not conducive to the improvement of battery capacity. Therefore, a thick-coated positive electrode film layer with lamination design is conducive to improving battery capacity and stability in the cycle process. A lamination process usually includes preparation, die cutting, stacking and other steps for the electrode plate, and in the process of die-cutting an electrode plate of a laminated battery, compared with the wound battery, the electrode plate is only stressed on one side; therefore, the edge is prone to microcracks, burrs or local tears during the punching process, resulting in the current collector to be exposed; especially when a cutter extrusion force acts on the thick-coated film layer, large particles in the film layer are prone to stress concentration in a cutting region of the current collector, resulting in loosening of the particles in the film layer, or even falling off, and causing the current collector to be exposed. Lithium-containing transition metal phosphate materials are generally prepared by sintering at high temperature, the applicant researched and found that with the melting of grain boundaries and the growth of particles, a sphericity of the particles would decrease, and the decrease in the sphericity of large particles would further lead to increase in the stress concentration of large particles on the current collector, thus increasing the risk of leakage of the current collector after die cutting of the electrode plates, aggravating side reaction of the electrolyte solution in the battery and micro-short circuit inside the battery, increasing the risk of self-discharge of the battery, deteriorating the battery life and even causing safety problems. In addition, compared with ternary materials, the lithium-containing transition metal phosphate materials have a more stable structure and are not easy to break under high pressure, and the lithium-containing transition metal phosphate particles need to resist greater pressure to achieve the increase in the compacted density of the electrode plate during an electrode plate compaction process, which makes the stress concentration phenomenon in the electrode plate more significant, resulting in a significant increase in the risk of leakage of the current collector after die cutting.

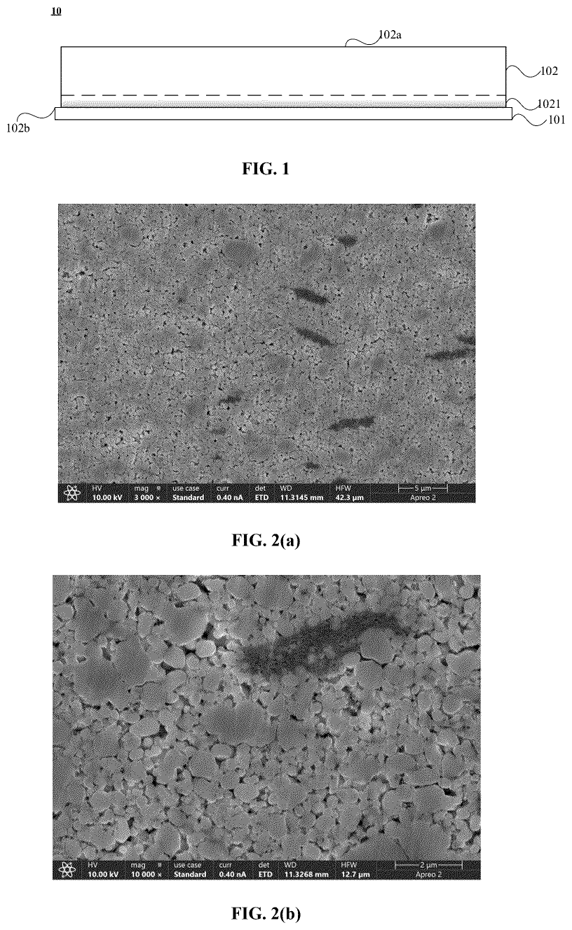

In a first aspect, the present application provides a battery cell which includes a stacked electrode assembly, and the stacked electrode assembly includes a positive electrode plate and a negative electrode plate; as shown in FIG. 1, the positive electrode plate 10 includes a positive electrode current collector 101, and a positive electrode film layer 102 disposed on at least one side of the positive electrode current collector 101;

the positive electrode film layer 102 includes lithium-containing transition metal phosphate particles, and at least part of surfaces of the lithium-containing transition metal phosphate particles are provided with a carbon material; a single-side thickness of the positive electrode film layer 102 is recorded as H, H is 70-120 μm; the positive electrode film layer 102 includes a first region 1021 which is arranged at the bottom, close to the positive electrode current collector 101, of the positive electrode film layer 102; based on the total area of the particles in the section along the thickness direction of the electrode plate in the first region 1021, the area proportion of first particles with a particle size R1 meeting R1≥1000 nm is 12%-50%; and in a cumulative distribution curve of sphericity area of the first particles with a particle size R1 meeting R1≥1000 nm in the section along the thickness direction of the electrode plate in the first region 1021, a median L_{R1A1}50 of sphericity is 0.6-0.8; and when the battery cell is in a full-discharge state, the compacted density of the positive electrode plate is 2.3 g/cm³ to 2.6 g/cm³.

The gram capacity of lithium-containing transition metal phosphate materials is relatively low, and researches show that when the single-side thickness H of the positive electrode film layer is less than 70 μm, it is difficult for the battery capacity to meet market demand. The particles of the lithium-containing transition metal phosphate materials are generally nano-sized, and the applicant found that if it is needed to improve the compacted density of the film layer, it is needed to add a certain amount of first particles with a particle size R1 meeting R1≥1000 nm to the film layer. The researches show that when the area proportion of the first particles with a particle size R1 meeting R1≥1000 nm in the positive electrode film layer is less than 12% based on the total area of the particles in the section along the thickness direction of the electrode plate in the first region, the grading of the particles in the positive electrode film layer and the improvement of the compacted density will be limited, and consequently, the battery capacity cannot be effectively improved. When the battery cell is in the full-discharge state and the compacted density of the positive electrode plate is less than 2.3 g/cm³, on one hand, the battery cannot achieve high capacity, and on the other hand, it is difficult for the positive electrode film layer to achieve effective particle connection, which influences the conduction smoothness of electron and ion and increases the battery impedance. When the area proportion of the first particles with a particle size R1 meeting R1≥1000 nm in the positive electrode film layer is greater than 50% based on the total area of the particles in the section along the thickness direction of the electrode plate in the first region, or the compacted density of the positive electrode plate of the battery cell in the full-discharge state is greater than 2.6 g/cm³, or in the cumulative distribution curve of sphericity area of the first particles in the section along the thickness direction of the electrode plate in the first region, the median L_{R1A1}50 of sphericity is 0.6, a thick-coated film layer is prone to stress concentration on large particles during die cutting of the electrode plate, which causes obvious leakage of current collectors after die cutting of the electrode plate.

It is to be understood that the lithium-containing transition metal phosphate particles are generally formed by sintering at a high temperature, and with the melting of grain boundaries and the growth of particles, the sphericity of the particles will decrease. In the first region, when the area proportion of the first particles with a particle size R1 meeting R1≥1000 nm is 12-50% based on the total area of the particles in the section along the thickness direction of the electrode plate in the first region, the sphericity median of the first particles generally does not exceed 0.8.

According to the embodiment of the present application, the battery capacity is improved by the stacked electrode assembly in cooperation with the thick-coated lithium-containing transition metal phosphate positive electrode film layer. Moreover, by reducing the content of large-particle lithium-containing transition metal phosphate close to the current collector in the positive electrode film layer, increasing the sphericity of the large-particle lithium-containing transition metal phosphate and reducing the compacted density of the positive electrode film layer, the stress concentration between the positive electrode film layer and the current collector is relieved, the phenomenon that the film layer of the stacked electrode assembly is loosened and even falls off in the die cutting process is relieved, and thus potential safety hazard is reduced.

According to the present application, the stacked electrode assembly refers to a cell formed by stacking a positive electrode plate, a separator and a negative electrode plate together.

The lithium-containing transition metal phosphate materials refer to a phosphate material containing a lithium element and a transition metal element and can be detected by any known mode in the field. For example, the lithium-containing transition metal phosphate materials can be detected through combination of an X-ray diffractometer (XRD), an energy spectrum analyzer and an inductively coupled plasma mass spectrometer.

As shown in FIG. 1, the single-side thickness H of the positive electrode film layer refers to a distance from a first surface 102a, far away from the positive electrode current collector 101, of the positive electrode film layer 102 to a second surface 102b opposite to the first surface 102a. It is to be noted that the positive electrode film layer contains lithium-containing transition metal phosphate particles, but does not only refer to the positive electrode active material layer, and other film layers which are connected to the positive electrode active material layer and are difficult to be distinguished, such as the primer and a liquid retaining layer, are all called the positive electrode film layer.

The thickness of the positive electrode film layer can be detected by any known mode in the field. As an example, the thickness of the positive electrode film layer in the section of the positive electrode plate along the thickness direction is measured by a scanning electron microscope. Three different positions are randomly selected for measurement, and an average value is obtained to serve as the thickness of the positive electrode film layer.

In some embodiments, the single-side thickness H of the positive electrode film layer is optionally 70 μm, 72.34 μm, 71 μm, 72 μm, 73 μm, 74 μm, 75 μm, 76 μm, 77 μm, 78 μm, 79 μm, 80 μm, 81 μm, 82 μm, 83 μm, 83.91 μm, 84 μm, 85 μm, 86 μm, 87 μm, 88 μm, 89 μm, 90 μm, 91 μm, 91.88 μm, 92 μm, 93 μm, 94 μm, 95 μm, 96 μm, 97 μm, 98 μm, 98.93 μm, 99 μm, 100 μm, 101 μm, 102 μm, 103 μm, 104 μm, 105 μm, 105.44 μm, 105.64 μm, 105.65 μm, 105.89 μm, 106 μm, 106.21 μm, 106.34 μm, 107 μm, 108 μm, 109 μm, 110 μm, 111 μm, 112 μm, 113 μm, 114 μm, 115 μm, 116 μm, 116.09 μm, 117 μm, 118 μm, 119 μm, 120 μm or a numerical range between any two of them.

In some embodiments, with reference to FIG. 1, the positive electrode film layer 102 includes a first region 1021 which is located at the bottom, close to the positive electrode current collector 101, of the positive electrode film layer 102; and based on the total area of particles in the section along the thickness direction of the electrode plate in the first region 1021, the area proportion of the first particles with a particle size R1 meeting R1≥1000 nm is 12%-50%.

In the present application, the first region of the positive electrode film layer refers to a region which is located at the bottom, close to the current collector, of the positive electrode film layer and is evenly distributed with the positive electrode active material. As an example, when the surface of the positive electrode current collector is directly coated with the positive electrode active material layer, the region within a thickness range of 20 μm from the second surface 102b (also the upper surface of the current collector) of the positive electrode film layer is marked as the first region of the positive electrode film layer. When the surface of the positive electrode current collector is coated with the primer and then coated with the positive electrode active material layer, the region within the thickness range of 5-20 μm from the second surface 102b of the positive electrode film layer serves as the first region, and therefore the influence of the primer on the test result is reduced.

In some embodiments, the first region of the positive electrode film layer is the region within the thickness range of 20 μm from the second surface 102b of the positive electrode film layer.

In some embodiments, the first region of the positive electrode film layer is the region within the thickness range of 5-20 μm from the second surface 102b of the positive electrode film layer.

In the present application, the term “particle” refers to particles having recognizable complete boundaries in the field of view in the positive electrode film at a certain magnification, such as 10,000 times, and there may be defects or scratches inside the particles, but complete boundaries that can divide the particles cannot be identified inside the particles.

A particle identification method specifically includes the following steps: cutting the positive electrode film layer along the thickness direction of the electrode plate by an argon ion beam (as an example, optionally, device model: Leica EM TIC 3X CP; working voltage: 6 kV; working hours: 6 h); and after exposing the section, observing the section of the positive electrode film layer along the thickness direction of the electrode plate by a scanning electron micrograph (as an example, optionally, device model: Hitachi SU8230; working voltage: 3 kV; the beam current: high; probe model: U (LA100); working distance: <5 mm). A field emission scanning electron micrograph is adopted to acquire images at a non-edge position in the section of the positive electrode film layer by a secondary electron mode (after the edge of the electrode plate is observed by the scanning electron micrograph, the view is adjusted to the center of the sample), an electron micrograph is shot under 10k times of amplification ratio, and the particles in the electron micrograph are analyzed by ImageJ software (1.46r, win64 version). A use method for the ImageJ software specifically includes: loading a scanning electron micrograph to be analyzed; identifying the particles by Cellpose plug-in software, and accordingly carrying out manual correction; and reading and counting data by the Image J. A specific method for identifying the particles by the Cellpose plug-in software includes the following steps: setting a segmentation diameter parameter (diameter in a Segmantation module) to be 15 pixels; and after clicking “run cyto3” for particle identification, manually identifying the particles which are not identified by the software or are not completely identified by the software or have identification errors in the image. The particles which are not identified by software or are not completely identified by the software or have identification errors in the image mainly include: 1, the particles are too large or scratches are formed in the surfaces of the particles, consequently, the particles cannot be identified or cannot be completely identified; 2, scratches will be generated in the surfaces of the particles in an argon ion beam cutting process, and the software may misjudge the scratches as particle boundaries in the identification process, resulting in identification errors; 3, the particles are too small and are not successfully identified; and 4, the particles are at the edge of the visual field of the electron micrograph, the edges penetrate through the interiors of the particles, the appearance is not completely displayed, and local appearance instead of the whole appearance is identified, resulting in identification errors. The above particles which are not identified or have identification errors are manually calibrated by the following specific processes: deleting large particles which are located at the peripheral edge of the scanning electron micrograph and are not completely displayed; determining whether there are gap scratches in other particles which are not identified or have identification errors or not, if there are no gap scratches in the particles, determining the particles as one particle, and manually identifying the particles according to the manually observed particle boundaries; in response to the gap scratches in the particles, determining whether the gap scratches penetrate through the particles or not, if not, determining the particles as one particle, and manually identifying the particles; in response to the gap scratches penetrating through the particles, determining whether the gap scratches are linear or irregular; in response to that the gap scratches are irregular, determining the gap scratches as boundaries among the particles, and dividing the particles along the boundaries; in response to that the gap scratches are linear, carrying out contrast comparison; in response to that the contrast comparison is not obvious and there is no crack sense, determining the gap scratches as one particle; and in response to that the contrast comparison is strong and there is crack sense, determining the gap scratches as two particles. The above particles which are not identified or have identification errors are manually calibrated by the following specific processes: deleting large particles which are located at the peripheral edge of the scanning electron micrograph and are not completely displayed; determining whether there are gap scratches in other particles which are not identified or have identification errors or not, if there are no gap scratches in the particles, determining the particles as one particle, and manually identifying the particles according to the manually observed particle boundaries; in response to the gap scratches in the particles, determining whether the gap scratches penetrate through the particles or not, if not, determining the particles as one particle, and manually identifying the particles; in response to the gap scratches penetrating through the particles, determining whether the gap scratches are linear or irregular; in response to that the gap scratches are irregular, determining the gap scratches as boundaries among the particles, and dividing the particles along the boundaries; in response to that the gap scratches are linear, carrying out contrast comparison; in response to that the contrast comparison is not obvious and there is no crack sense, determining the gap scratches as one particle; and in response to that the contrast comparison is strong and there is crack sense, determining the gap scratches as two particles. After manual identification, information irrelevant to the particle boundaries is deleted in an automatic processing process, namely, determination and identification of the particles in the image are completed.

In the section along the thickness direction of the electrode plate in the first region, the area proportion of the first particles with a particle size R1 meeting R1≥1000 nm can visually reflect a proportional relationship between the area of part of particles and the area of all the particles in the section with this particle size and reflect the area of the particles in the section with this particle size.

It is to be understood that the particles in the section along the thickness direction of the electrode plate in the first region, especially the particles over 50 nm, are mainly derived from the positive electrode active material. Therefore, in the embodiment of the present application, the distribution condition of the lithium-containing transition metal phosphate particles in the first region can be accurately and objectively reflected by observation and statistics on the area of the particles in the section along the thickness direction of the electrode plate in the first region.

In the related technology, a laser particle analyzer is usually adopted to count the particle size of the positive electrode active materials by Malvern laser diffraction. However, the applicant researched and showed that because the lithium-containing transition metal phosphate particles are prone to agglomeration, the test results obtained by the Malvern laser diffraction according to the laser scattering principle are often the particle size of particle aggregates, which cannot truly reflect the particle size of the particles in the positive electrode active material, and also cannot reflect the dispersion state of the positive electrode active material in the film layer because the dispersion degree of the positive electrode active material in the film layer will be improved in the process of pulping and film formation. The test results obtained by the Malvern laser diffraction are affected by the particle size, specific surface area, and agglomeration degree of the positive electrode active material, and compared with the real dispersion in the electrode plate, the number of large particles obtained by the test is lower than the actual value and the number of small particles is higher than the actual value, so the particle size obtained by the Malvern laser diffraction test cannot be equal to or analogous to the statistical particle size obtained in the embodiment of the present application.

A method for testing the area proportion of the first particles with a particle size R1 meeting R1≥1000 nm in the section along the thickness direction of the electrode plate in the first region includes the following specific steps: identifying the particles in the first region with reference to the above method in the present application, importing a picture subjected to particle determination and identification into ImageJ software for analysis, implementing scale setting according to the scanning electron micrograph, and carrying out statistical analysis on the particle size, area, sphericity and roughness of the particles in the section along the thickness direction of the electrode plate in the positive electrode film layer through analysis functions of “Feret”, “Area”, “Round” and “Solidity”. According to the software user guide (ImageJ User Guide IJ 1.46r), the parameter “Feret” obtained by analysis indicates the maximum spacing between all parallel lines in a two-dimensional projection of the particles, which represents the particle size of the particles; and the obtained parameter “Area” indicates a pixel area of the particles. The particles with the particle size less than 50 nm have a relatively great error in the statistical process, making it difficult to accurately identify, and the particle size of the conductive agent is generally less than 50 nm, which will cause relatively great error in the statistical result, and therefore, the particles with the particle size less than 50 nm are not counted in the particle size counting process in the present application, and the statistical data of the particles corresponding to Area, Round or Solidity displayed as “NaN” are deleted. A sum of the parameter “Area” of the particles with a particle size R1 meeting R1≥1000 nm and the sum of the parameter “Area” of all the particles are calculated and treated as the area of the particles with a particle size R1 meeting R1≥1000 nm and the total area of the counted particles respectively. The sum of the area of the particles with particle size R1 meeting R1≥1000 nm is divided by the total area of the counted particles, which is used as the area proportion of the first particle with particle size R1 meeting R1≥1000 nm in the section surface along the thickness direction of the electrode plate in the first region.

In some embodiments, based on the total area of the particles in the section along the thickness direction of the electrode plate in the first region, the area proportion of first particles with a particle size R1 meeting R1≥1000 nm is optionally 12%, 12.02%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 34.78%, 34.95%, 35%, 36%, 36.29%, 36.37%, 36.64%, 36.88%, 37%, 38%, 38.09%, 38.44%, 39%, 40%, 41%, 42%, 43%, 44%, 45%, 46%, 47%, 48%, 49%, 49.96%, 50% or a numerical range between any two of them.

In some embodiments, in the cumulative distribution curve of sphericity area of the first particles in the section along the thickness direction of the electrode plate in the first region, the median L_{R1A1}50 of sphericity is 0.6-0.8.

A method for testing the sphericity of the first particles in the section along the thickness direction of the electrode plate in the first region includes the following specific steps: identifying the first particles in the section in the first region with reference to the above method in the present application, and analyzing the appearance of the particles in the section along the thickness direction of the electrode plate in the first region by a “shape description” analysis function in ImageJ. According to the software user guide (ImageJ User Guide IJ 1.46r), the parameter “Round” obtained by analysis represents the ratio of the pixel area of the particles to the area of a round taking a fitted long diameter as the diameter and can be used for representing the sphericity of the particles. When the particles are closer to a round, the ratio of the pixel area to the area of the circle taking the fitted long diameter as the diameter is closer to 1. Therefore, the parameter “Round” of the particles obtained by analysis represents the sphericity of the particles. The particles with the particle size less than 50 nm have relatively great errors in the counting process, making it difficult to accurately identify, and moreover, the particle size of the conductive agent is generally less than 50 nm, which will result in relatively great errors in the counting result, and therefore, in the present application, the particles with the particle size less than 50 nm are not counted in the particle size counting process and the particle counting data corresponding to Round displayed as “NaN” is deleted. According to the above method, in order to meet the sample number with statistical significance, at least 10 scanning electron micrographs with non-overlapped view fields are collected from each electrode plate. The obtained sphericity of at least 1,000 obtained particles is arranged according to an ascending sequence, taking the sphericity as a horizontal axis, and taking the cumulative area proportion as a vertical axis so as to obtain the cumulative distribution curve of sphericity of the first particles in the first region. The L_{R1A1}50 is the corresponding sphericity L value at which the cumulative area proportion of the vertical axis is 50% in the cumulative distribution curve of sphericity L value of the first particles.

In some embodiments, in the cumulative distribution curve of sphericity area of the first particles in the section along the thickness direction of the electrode plate in the first region, the median L_{R1A1}50 of sphericity is optionally 0.60, 0.61, 0.62, 0.63, 0.631, 0.64, 0.65, 0.653, 0.66, 0.67, 0.673, 0.68, 0.685, 0.687, 0.688, 0.69, 0.70, 0.705, 0.71, 0.72, 0.73, 0.74, 0.745, 0.75, 0.76, 0.77, 0.78, 0.79, 0.80 or a numerical range between any two of them.

Those skilled in the art can implement regulation and control on the sphericity of the particles by any known method. As an example, the sphericity of the particles can be adjusted by processes of grinding, polishing, chemical corrosion, mechanical stirring, extruding, coating, granulating, adding a surfactant and the like, and by adjusting the parameters of each process.

In some embodiments, when the battery cell is in the full-discharge state, the compacted density of the positive electrode plate is 2.3 g/cm³ to 2.6 g/cm³.

In present invention, the full-discharge status refers to a status that the battery is placed in a drying oven at 25 °C and stood for 2 h, and when the temperature of the battery is maintained at 25 °C, the battery is discharged to 2.5V with constant current of 1/3 C and then discharged to 2.0V with a constant current of 0.1 C.

The compacted density of the positive electrode film layer can be tested by the known mode in the field. As an example, the battery is placed in a drying oven at 25 °C and stood for 2 h; when the temperature of the battery is maintained at 25 °C, the battery is discharged to be 2.5V with constant current of 1/3 C and then discharged to be 2.0V with constant current of 0.1 C; then he battery is disassembled to obtain the positive electrode plate; the residual electrolyte solution is treated with a dimethyl carbonate solvent; the electrode plate is dried and cut into small wafers with the area of S, and the mass W₁ of the electrode plate is obtained; the thickness T₁ of the positive electrode plate is measured with a ten-thousandth micrometer; then the positive electrode film layer of the weighed electrode plate is wiped off; the mass of the current collector is weighed and recorded as W₂; and the thickness T₂ of the current collector is measured with the ten-thousandth micrometer, and the compacted density of the positive electrode film layer is shown as PD=(W₁−W₂)/[(T₁−T₂)×S].

In some embodiments, when the battery is in the full-discharge state, the compactness density of the positive electrode sheet is optionally 2.3 g/cm³, 2.31 g/cm³, 2.32 g/cm³, 2.33 g/cm³, 2.34 g/cm³, 2.35 g/cm³, 2.36 g/cm³, 2.37 g/cm³, 2.38 g/cm³, 2.39 g/cm³, 2.40 g/cm³, 2.41 g/cm³, 2.42 g/cm³, 2.43 g/cm³, 2.44 g/cm³, 2.45 g/cm³, 2.46 g/cm³, 2.47 g/cm³, 2.48 g/cm³, 2.49 g/cm³, 2.50 g/cm³, 2.51 g/cm³, 2.52 g/cm³, 2.53 g/cm³, 2.54 g/cm³, 2.55 g/cm³, 2.56 g/cm³, 2.57 g/cm³, 2.58 g/cm³, 2.59 g/cm³, 2.60 g/cm³ or a numerical range between any two of them.

In some embodiments, the single-side thickness of the positive electrode film layer is recorded as H, and His 90-120 μm.

The single-side thickness of the positive electrode film layer is within the above range, which is conducive to further improving the battery capacity.

In some embodiments, the single-side thickness of the positive electrode film layer is recorded as H, and His 100-120 μm.

The battery capacity can be further improved by further increasing the single-side thickness of the positive electrode film layer, but the applicant found that when the single-side thickness of the positive electrode film layer was greater than or equal to 100 μm, the phenomenon of current collector exposed from the positive electrode plate was more serious; according to the embodiment of the present application, by reducing the content of large-particle lithium-containing transition metal phosphate close to the current collector in the positive electrode film layer, increasing the sphericity of the large-particle lithium-containing transition metal phosphate and reducing the compacted density of the positive electrode film layer, the stress concentration between the positive electrode film layer and the current collector can be relieved, the phenomenon that the thick-coated film layer in the positive electrode plate is loosened and even falls off in the die cutting process is greatly reduced, and thus the potential safety hazard is reduced on the basis of keeping relatively high capacity of the battery.

In some embodiments, the positive electrode film layer also includes a conductive agent; and based on the total area of the section of the positive electrode plate along the thickness direction of the positive electrode film layer, the total area of an agglomeration region of the conductive agent accounts for 0.2%-6%, optionally, 1.5%-5%.

In some embodiments, the positive electrode film layer also includes the conductive agent; and based on the total area of the section of the positive electrode plate along the thickness direction of the positive electrode film layer, the total area proportion of an agglomeration region of the conductive agent is optionally 0.2%, 0.3%, 0.4%, 0.5%, 0.6%, 0.7%, 0.8%, 0.9%, 1%, 1.1%, 1.2%, 1.3%, 1.4%, 1.5%, 1.6%, 1.7%, 1.8%, 1.9%, 1.99%, 2%, 2.5%, 3%, 3.5%, 4%, 4.5%, 5%, 5.5%, 5.82%, 6% or a numerical range between any two of them.

Based on the total area of the section of the positive electrode film layer along the thickness direction of the electrode plate, the total area proportion of the agglomeration region of the conductive agent is within the above range, which indicates that the conductive agent in the positive electrode film layer is uniformly dispersed and easy to form a uniform conductive network, it is particularly conducive to reducing the problem of dynamics reduction of the thick-coated film layer caused by the increase in an ion transmission path, and reducing the problems of local polarization and even lithium precipitation of the battery in the cycle process.

Moreover, the researches show that large-size first particles in the lithium-containing transition metal phosphate are easy to rebound, the agglomeration area of the conductive agent is within the above range, thus the rebound of the lithium-containing transition metal phosphate particles can be inhibited by means of the uniform distribution of the conductive agent, mechanical constraint can be performed on the particles and even the film layer, thereby improving the cohesion of the film layer, reducing the phenomena of powder falling and falling of the film layer, as well as prolonging the cycle life of the battery.

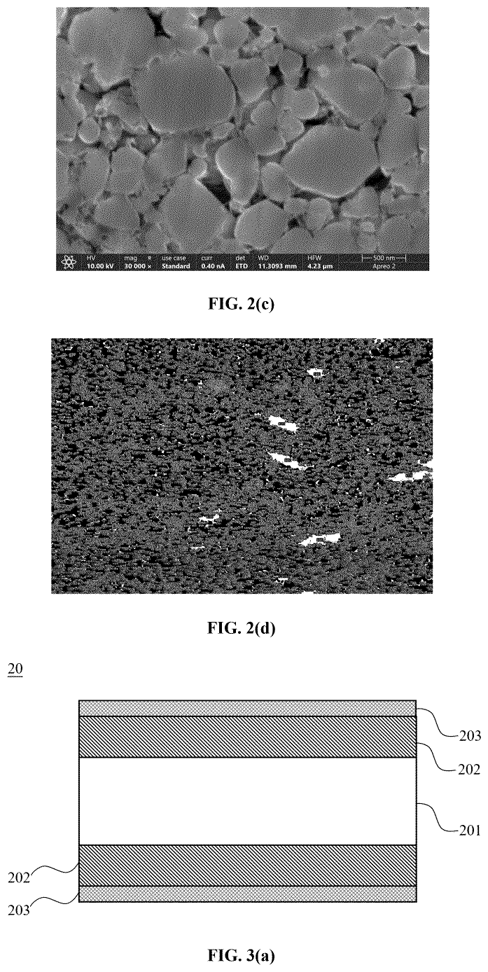

Based on the total area of the section of the positive electrode film layer along the thickness direction of the electrode plate, the total area proportion of the agglomeration region of the conductive agent can be tested by the following method. As shown in FIG. 2a, the section of the positive electrode film layer along the thickness direction of the electrode plate is observed by the above similar method using the scanning electron microscope, and the area of the agglomeration region of the conductive agent in the scanning electron micrograph is measured under 3k times of amplification factor. The conductive agent is generally made of carbon-based materials, such as conductive carbon black and carbon nanotubes, so the agglomeration region of the conductive agent is in a black agglomeration shape compared with other regions in the positive electrode film layer; and under high-rate amplification factor, the agglomerated conductive agent can be observed, as shown in FIG. 2b and FIG. 2c. The agglomeration region of the conductive agent refers to a black region range in which the conductive agent is obviously agglomerated in the electron micrograph. As shown in FIG. 2d, the area of the agglomeration region of the conductive agent is analyzed by image analysis software, for example, a white mark region in the electron micrograph is counted by the ImageJ, and a region with Feret displayed more than or equal to 2 μm is screened out; the sum of the area of the above regions is the total area of the agglomeration region of the conductive agent in the scanning electron micrograph; and the area proportion of the agglomeration region of the conductive agent is represented by dividing the total area of the agglomeration region of the conductive agent, which is obtained by testing in the scanning electron micrograph under the 3k times of amplification factor, by the area of the scanning electron micrograph. Three scanning electron micrographs with non-overlapped ranges are randomly selected and an average value is obtained to be used as “the total area proportion of the agglomeration region of the conductive agent based on the total area of the section of the positive electrode film layer along the thickness direction of the electrode plate”.

In some embodiments, the conductive agent includes carbon nanotubes which include one or more of a single-walled carbon nanotube, a few-walled carbon nanotube and a multi-walled carbon nanotube, optionally, the conductive agent also includes conductive carbon black.

The carbon nanotubes have a high length-diameter ratio, which is conducive to overlapping a plurality of positive electrode particles and negative electrode particles in the thickness direction to form a long-range conductive path and improve the constraint force among the particles at the same time, thereby improving the dynamics performance of the thick-coated positive electrode film layer, reducing the problems of local polarization and even lithium precipitation of the battery in the cycle process, and prolonging the cycle life of the battery; and moreover, by the constraint effect, the rebound phenomena of the large particles in the thick-coated film layer and a thick film layer can be reduced, and the phenomenon of falling of the film layer is reduced.

The conductive carbon black has a small size, and is attached to the surfaces of the positive electrode particles and filled among gaps of the positive electrode particles to realize dense point-shaped conductive contact. The conductive carbon black and the positive electrode particles are used in match to realize long-distance conduction and short-distance conduction, which is conducive to further perfecting the conductive network in the positive electrode film layer. Moreover, the conductive agent has a large specific surface area, which facilitates liquid absorption and liquid retention, and reduces a phenomenon of electrolyte solution extrusion caused by high expansion force increase amplitude of the thick-coated electrode plate in a long cycle process, thereby prolonging the long cycle life of the battery.

In some embodiments, the agglomeration region of the conductive agent includes carbon nanotubes and conductive carbon black.

Researchers found that the carbon nanotubes are prone to agglomeration due to high surface energy, resulting in uneven dispersion in the positive electrode film layer, and inability to form an effective carbon nanotube network structure. The surface energy of the conductive carbon black is close to that of the carbon nanotubes, so the conductive carbon black can be adsorbed on the surfaces of the carbon nanotubes to form a physical barrier, which increases the agglomeration resistance of the carbon nanotubes, reduces direct contact among the carbon nanotubes, thus inhibiting the agglomeration phenomenon, and improving the distribution uniformity of the carbon nanotubes in the positive electrode film layer. On one hand, it is conducive to improving the conductivity of the thick-coated positive electrode film layer, thus improving the dynamics performance of the battery; and on the other hand, the constraint effect of the carbon nanotubes on the positive electrode film layer is exerted, thus reducing the risk that the thick-coated positive electrode film layer falls off, and further improving the dynamics performance of the battery and prolonging the cycle life of the battery. In addition, the agglomeration of the carbon nanotubes in the agglomeration region of the conductive agent may cause blockage of the local ion transmission path of the agglomeration region of the conductive agent, and the conductive carbon black is matched to use, which can improve the lithium ion transmission capacity in this region, reduce local polarization, thereby further improving the cycle stability of the battery.

In any embodiment, based on a mass of the positive electrode film layer, a mass content C1 of the carbon nanotubes meets: 0<C1≤2.5%, and a mass content C2 of the conductive carbon black meets: 0<C2≤2.5%.

In some embodiments, based on the mass of the positive electrode film layer, the mass content C1 of the carbon nanotubes is optionally 0.1%, 0.2%, 0.3%, 0.4%, 0.5%, 0.6%, 0.7%, 0.8%, 0.9%, 1%, 1.1%, 1.2%, 1.3%, 1.4%, 1.5%, 1.6%, 1.7%, 1.8%, 1.9%, 2.0%, 2.1%, 2.2%, 2.3%, 2.4%, 2.5% or a numerical range between any two of them of them.

In some embodiments, based on the mass of the positive electrode film layer, the mass content C2 of conductive carbon black is optionally 0.1%, 0.2%, 0.3%, 0.4%, 0.5%, 0.6%, 0.7%, 0.8%, 0.9%, 1%, 1.1%, 1.2%, 1.3%, 1.4%, 1.5%, 1.6%, 1.7%, 1.8%, 1.9%, 2.0%, 2.1%, 2.2%, 2.3%, 2.4%, 2.5% or a numerical range between any two of them of the mass contents.

The mass content of the carbon nanotubes and the conductive carbon black is within the above range, so that the agglomeration phenomenon of the carbon nanotubes can be effectively relieved and a good conductive network structure can be formed, thereby effectively relieving the stress concentration of the positive electrode film layer, improving the liquid retention rate of the positive electrode film layer in the long cycle process, further reducing the falling risk and the polarization degree of the electrode plate film layer, improving the dynamics performance of the battery, as well as prolonging the cycle life of the battery.

In some embodiments, the positive electrode film layer also includes a dispersant which includes hydrogenated nitrile butadiene rubber (HNBR).

Polar groups (such as cyano groups, —CN) in HNBR molecules can interact with hydroxyl group (—OH) or metal oxide sites on the surfaces of the lithium-containing transition metal phosphate particles (such as hydrogen bonds, and dipole-dipole interaction), which enhances the compatibility of the particles and a solvent, and reduces the interfacial tension of the particles and the solvent, especially the interfacial tension of the large particles, thus the particles are easier to disperse uniformly, the aggregation caused by hydrophobicity can be reduced, the dispersibility of the large particles in the positive electrode film layer can be improved, and the stress concentration in the die cutting process of the thick-coated film layer can be reduced.

Moreover, when slurry is dried to form a film, an elastic network structure of the HNBR can buffer shrinkage stress generated by solvent volatilization, thus the re-aggregation of the conductive agent due to capillary force in this process can be reduced, the area proportion of the aggregation region of the conductive agent is reduced, and the cycle life of the battery is prolonged.

In some embodiments, based on the mass of the positive electrode film layer, the mass content of the dispersant is 0.5%-2%.

In some embodiments, based on the mass of the positive electrode film layer, the mass content of the dispersant is optionally 0.5%, 0.6%, 0.7%, 0.8%, 0.9%, 1%, 1.1%, 1.2%, 1.3%, 1.4%, 1.5%, 1.6%, 1.7%, 1.8%, 1.9%, 2% or a numerical range between any two of them of them.

The mass content of the dispersant is within the above range, so that uniform dispersion of the large particles in the positive electrode film layer can be achieved when the positive electrode film layer is kept to have a high-content positive electrode active material, the stress concentration caused by local particle accumulation can be reduced, the phenomenon that the film layer of the stacked electrode assembly is loosened and even falls off in the die cutting process is relieved and the potential safety hazard is reduced.

In some embodiments, the lithium-containing transition metal phosphate particles in the positive electrode film layer include components shown in the following general formula:

LiₘFeₓP_{y}OⱼQ_{q} Formula I,
in which, Q includes one or more of Al, Na, K, Mg, Cu, Mn, Cr, Zn, Pb, Ca, Co, Ni, Sr, Nb, V, Ti, B, S, Si, N, F, Cl, and Br, 0.8≤m≤1.15, 0.9≤x≤1, 0.95≤y≤1, 3.5≤j≤4, 0≤q≤0.1.

In some embodiments, m is optionally 0.8, 0.85, 0.9, 0.95, 0.98, 1.00, 1.03, 1.05, 1.08, 1.10, 1.13, 1.15 or a numerical range between any two of them of them; x is optionally 0.9, 0.91, 0.92, 0.93, 0.94, 0.95, 0.96, 0.97, 0.98, 0.99, 1.0 or a numerical range between any two of them of them; y is optionally 0.95, 0.96, 0.97, 0.98, 0.99, 1.00 or a numerical range between any two of them of them; j is optionally 3.5, 3.6, 3.7, 3.8, 3.9, 4 or a numerical range between any two of them of them; and q is optionally 0, 0.01, 0.02, 0.03, 0.04, 0.05, 0.06, 0.07, 0.08, 0.09, 0.1 or a numerical range between any two of them of them.

In some embodiments, the lithium-containing transition metal phosphate particles include a titanium element; and based on the total mass of the lithium-containing transition metal phosphate particles in the positive electrode film layer, the mass content of the titanium element is 500-8,000 ppm, optionally, 1,000-3,000 ppm.

In some embodiments, the titanium element is uniformly distributed in the lithium-containing transition metal phosphate particles.

The types and content of elements in the lithium-containing transition metal phosphate particles in the positive electrode film layer can be tested by any known mode in the field. As an example, the titanium element and the content thereof are tested by an inductively coupled plasma emission spectrometry with reference to Appendix C of GB/T 33822-2017.

When the titanium element is doped into the lithium-containing transition metal phosphate particles, a formed Ti—O—P bond has a strong binding effect; by anchoring a phosphate group, the shrinkage/expansion amplitude of a crystal lattice in lithium ion de-intercalation can be reduced, thus the structural stress caused by phase change is inhibited, and the cycle life of the battery can be prolonged; and furthermore, the Ti—O—P bond can provide a more stable channel for lithium ion diffusion, which reduces a migration energy barrier, and is conducive to improving the dynamics performance of the battery.

The mass content of the titanium element is within the above range, which is conducive to increasing the lithium ion transmission rate of the positive electrode active material, relieving the problems of long ion diffusion path and poor dynamics caused by the thick-coated electrode plate and the positive electrode film layer containing a certain amount of first particles, thereby reducing the lithium precipitation risk, and improving the dynamics performance of the battery.

In some embodiments, based on the total mass of the lithium-containing transition metal phosphate particles in the positive electrode film layer, the mass content of the titanium element is optionally 500 ppm, 1000 ppm, 1500 ppm, 2000 ppm, 2500 ppm, 3000 ppm, 3500 ppm, 4000 ppm, 4500 ppm, 5000 ppm, 5500 ppm, 6000 ppm, 6500 ppm, 7000 ppm, 7500 ppm, 8000 ppm or a numerical range between any two of them of them.

In some embodiments, the lithium-containing transition metal phosphate particles include a vanadium element; and based on the total mass of the lithium-containing transition metal phosphate particles in the positive electrode film layer, the mass content of the vanadium element is 500-5,000 ppm, optionally, 500-3,000 ppm.

In some embodiments, the vanadium element is uniformly distributed in the lithium-containing transition metal phosphate particles.

When the vanadium element is doped into the lithium-containing transition metal phosphate particles, a multi-valence characteristic is realized; when +5-valent vanadium (V⁵⁺) is doped into a phosphorus site, the radius increases, which leads to lattice distortion, then the lithium ion diffusion channel is expanded, and the ionic conductivity of the positive electrode active material is improved; and when +3-valent vanadium (V³⁺) is doped into a transition metal site, charges are compensated by a lithium vacancy or interstitial oxygen, a defect level is formed, and thus the electronic conductivity of the positive electrode active material is improved.

The mass content of the vanadium element is within above range, which is conducive to increasing the lithium ion transmission rate of the positive electrode active material, improving the electronic conductivity of the positive electrode active material, and further improving the dynamics performance of the battery in cooperation with the doped titanium element.

In some embodiments, based on the total mass of the lithium-containing transition metal phosphate particles in the positive electrode film layer, the mass content of the vanadium element is optionally 500 ppm, 1000 ppm, 1500 ppm, 2000 ppm, 2500 ppm, 3000 ppm, 3500 ppm, 4000 ppm, 4500 ppm, 5000 ppm or a numerical range between any two of them of them.

In some embodiments, the lithium-containing transition metal phosphate particles in the positive electrode film layer include one or more of lithium iron phosphate, lithium manganese phosphate, lithium vanadium fluorophosphate, lithium manganese iron phosphate and modified materials thereof.

In some embodiments, the lithium-containing transition metal phosphate particles in the positive electrode film layer include one or more of lithium iron phosphate and doped modified materials thereof, and coated modified materials thereof.

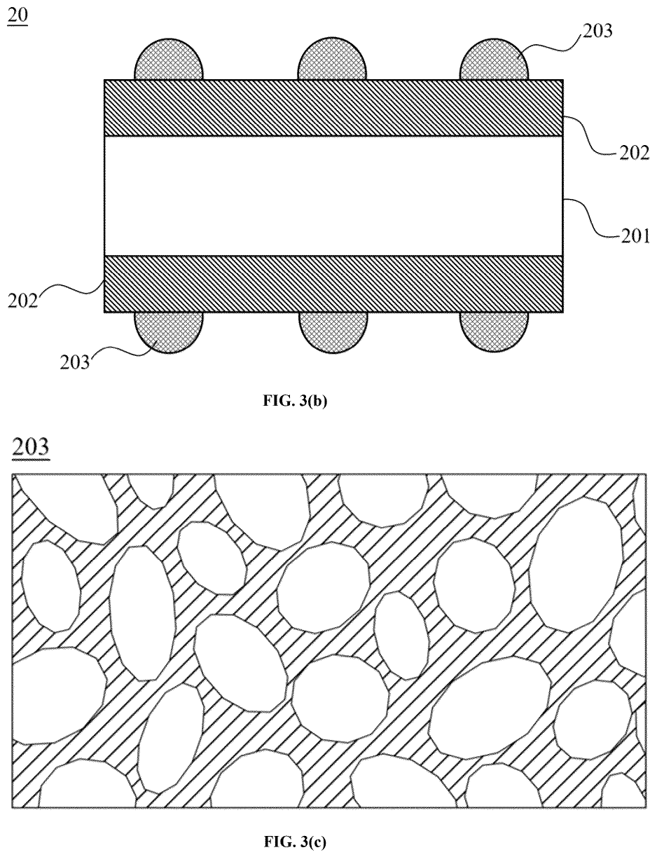

In some embodiments, as shown in FIG. 3a, the battery cell further includes a separator 20 arranged between the positive electrode plate and the negative electrode plate, and the separator 20 includes a base film 201, ceramic layers 202 disposed on two sides of the base film 201 and a binding layer 203 disposed on the side, far away from the base film 201, of the ceramic layer 202 on at least one side; and the binding layer 203 is a continuous layer of a porous structure and includes a vinylidene fluoride polymer.

In some embodiments, the vinylidene fluoride polymer includes a vinylidene fluoride homopolymer (PVDF) and a copolymer of vinylidene fluoride and other monomers, for example, a copolymer of vinylidene fluoride and hexafluoropropylene.

As shown in FIG. 3b, the binding layer of the separator in the related technology is generally water-based PVDF, which often presents an island-shaped structure in the separator, thus it is conducive to providing a gap for expansion of the cell, and facilitates manufacturing; however, the binding layer of this separator is low in binding area and relatively weak in binding force.

As shown in FIG. 3c, it is a schematic diagram of a surface appearance of a binding layer 203 of a separator in an embodiment of the present application; the binding layer of the separator in the embodiment of the present application has a certain pore structure in the continuous structure; and the ceramic layer arranged between the base film and the binding layer can be observed through the pore structure. It is to be understood that when the continuous layer of the porous structure is treated as the binding layer, the binding layer is possibly in contact with the positive electrode plate or the negative electrode plate or is extruded by stress to form a block shape in the electrode plate manufacturing or cycling process; in the present application, the continuous layer does not require the binding layer to be continuous in the whole battery, but refers to a continuous layer of a uniform porous structure at a micro level, such as observation under a microscope, instead of the island-shaped structure. In order to feed back the real appearance of the separator, in the sampling process, sampling is preferably performed in a region, with few binding with the positive electrode plate or the negative electrode plate, of the binding layer of the separator in the battery; and as an example, sampling is performed in a separator position with the projection exceeding the positive electrode plate and the negative electrode plate, or sampling is performed in the separator close to the surface of the electrode assembly. Therefore, the sampled separator can better reflect the real state of the separator.

According to the separator provided by the embodiment of the present application, the continuous layer of the porous structure is treated as the binding layer, which has a larger binding area than an island-shaped binding layer in related technology, thus the separator and the positive electrode film layer can be bonded firmer and more uniform; moreover, by means of the porous structure in the binding layer, the transmission efficiency of lithium ions, as well as the dynamics performance of the battery can be achieved at the same time. Moreover, compared with a wound cell, the stacked electrode assembly has the advantages that the compression force between the electrode plates is small in the cell preparation process, and the lithium-containing transition metal phosphate of the first particles with a particle size R1 meeting R1≥1000 nm can reduce the compact degree of internal components of a cell in the rebounding process, thereby improving the impedance of the cell and increasing the probability of powder falling and even falling of the film layer. According to the separator provided by the embodiment of the present application, the continuous layer of the porous structure is treated as the binding layer, it is particularly suitable for a thick-coated stacked electrode assembly, it can relieve the rebound phenomenon of the thick-coated stacked electrode assembly in the long cycle process, and improve the maintenance of the battery capacity in the long cycle process. In addition, the thick-coated stacked electrode assembly is prone to relative displacement between the electrode plate and the separator in the process of dragging an outer electrode plate and welding a tab, which easily causes powder falling of the film layer, even causes mutual overlapping of a positive electrode and a negative electrode, resulting in a risk of internal short circuit.

According to the embodiment of the present application, the continuous layer of the porous structure is treated as the binding layer, which keeps the air permeability and the porosity of the separator while improving the binding force between the separator and the electrode plate, improves the stability of the thick-coated film layer electrode plate, further reduces the risk of powder falling and even internal short circuit caused by relative displacement between the electrode plate and the separator, and improving the cycle stability of the battery.

In some embodiments, the material of the base film can include but is not limited to one or more of glass fiber, non-woven fabric, Polyethylene (PE) and Polpropylene (PP).

In the present application, the ceramic layer includes ceramic particles, and the ceramic particles include one or more of Al₂O₃, AlO(OH), SiO₂, TiO₂, MgO, CaO, ZnO₂, ZrO₂, SnO₂.

The ceramic particles have flame retardancy and a relatively high hardness value, and are not easy to deform when heated, so the ceramic particles are excellent in dimensional stability. The thermal conductivity of the ceramic material is low, so that the condition that some thermal runaway points in the battery are expanded to cause overall thermal runaway can be further prevented, and thus the safety performance of the battery cell is improved.

In some embodiments, the battery cell includes an electrolyte which includes a solvent, and the solvent includes one or two of Ethyl Methyl Carbonate (EMC) and Ethylene Carbonate (EC), and dimethyl carbonate (DMC).

The DMC has relatively good solubility on lithium hexafluorophosphate; an electrolyte solution can provide enough lithium ion concentration, so that necessary ion conduction conditions are provided for a charge-discharge process of a lithium-containing transition metal phosphate battery. Moreover, the DMC is low in viscosity, thus the moving rate of lithium ions can be increased, the fast charge performance of the battery can be improved, and the disadvantage that the long ion diffusion path of the thick-coated electrode plate and the positive electrode film layer containing a certain amount of first particles leads to reduction of dynamics performance is improved.

In some embodiments, the mass proportion of the dimethyl carbonate is 18%-32% based on the total mass of the electrolyte.

The types and mass of the solvent and an electrolyte salt in the electrolyte can be obtained by detecting the electrolyte by a method known by those skilled in the art. For example, the composition of the electrolyte solution can be measured by a liquid chromatography, an ultraviolet spectrophotometry, an ultraviolet-visible spectrophotometry and the like. Exemplarily, the battery cell is disassembled, a free electrolyte solution is obtained from the battery cell, the free electrolyte solution in the battery cell is diluted to 3-10 times by acetonitrile to obtain an electrolyte solution diluent to be tested, the electrolyte solution diluent is placed in an instrument for full-scanning qualitative analysis by a GC-MS 3100 organic component gas chromatograph, the temperature of a sample inlet is 250 °C, the scanning range is 35-270 μm, and the total ion current chromatogram of each organic substance is obtained after the test; and the corresponding organic substance types are compared according to the band positions of the chromatograms, and the corresponding content percentage of each organic substance is calculated according to the band area. Exemplarily, the content of inorganic substance in the electrolyte solution can be tested by an Ion Chromatograph (IC), a quantitative electrolyte solution (the concentration of the diluent is in the middle of a standard curve) is weighed, the volume is fixed to 100 mL with ultrapure water, sample feeding and detection are automatically carried out by the ion chromatograph, the ion chromatograms of the inorganic substances are tested, and the corresponding inorganic substances types are compared according to the band positions of the chromatograms.

In some embodiments, based on the total mass of the electrolyte, the mass proportion of dimethyl carbonate is optionally 18%, 19%, 20%, 21%, 22%, 23%, 24%, 25%, 26%, 27%, 28%, 29%, 30%, 31%, 32% or a numerical range between any two of them of them.

Because the flash point of the dimethyl carbonate is low, excessive content easily aggravates gas production when demoulding is performed on the electrode plate, internal resistance increases and heat production increases, thereby shortening the cycle life of the battery. The mass proportion of the DMC is within the above range, so the cycle life of the battery is prolonged while the battery has good fast charging performance.

In some embodiments, the total mass proportion of Ethyl Methyl Carbonate (EMC) and Ethylene Carbonate (EC) is 52%-71% based on the total mass of the electrolyte.

In some embodiments, based on the total mass of the electrolyte, the total mass proportion of EMC and EC is optionally 52%, 53%, 54%, 55%, 56%, 57%, 58%, 59%, 60%, 61%, 62%, 63%, 64%, 65%, 66%, 67%, 68%, 69%, 70%, 71% or a numerical range between any two of them.

In some embodiments, the electrolyte further includes Vinylene Carbonate (VC); and based on the total mass of the electrolyte, the mass proportion of the vinylene carbonate is 0.5%-1.5%.

The vinylene carbonate is subjected to a reduction reaction on the surface of the negative electrode prior to other solvent components to generate a dense SEI film rich in organic lithium compounds. The SEI film has high lithium ion conductivity, which is conducive to improving the dynamics performance of the battery cell; and moreover, the SEI film has high mechanical strength and chemical stability, so it can inhibit the electrolyte from being continuously decomposed, thereby reducing the consumption of active lithium and the gas production of side reactions.

In some embodiments, the electrolyte includes electrolyte salt which includes lithium hexafluorophosphate (LiPF₆), and the concentration of the lithium hexafluorophosphate in the electrolyte is 0.9-1.2 mol/L.

In some embodiments, the concentration of lithium hexafluorophosphate in the electrolyte is 0.9 mol/L, 0.95 mol/L, 1.0 mol/L, 1.05 mol/L, 1.1 mol/L, 1.2 mol/L or a numerical range between any two of them.

In some embodiments, based on the total area of the particles in the section along the thickness direction of the electrode plate in the first region, the area proportion of the particles with a particle size R1 meeting 1 μm≤R1≤5 μm is 12%-40%.

The area proportion of the particles with a particle size R1 meeting 1 μm≤R1≤5 μm in the first region is within above range, which is conducive to further reliving stress concentration between the positive electrode film layer and the current collector on the basis of keeping high capacity of the battery, relieving the phenomenon that the film layer of the stacked electrode assembly is loosened and even falls off in the die cutting process, thereby reducing the potential safety hazard.

In some embodiments, in the cumulative distribution curve of sphericity area of the particles with the particle size R1 meeting 1 μm≤R1≤5 μm in the section along the thickness direction of the electrode plate in the first region, the median L_{R1A2}50 of sphericity is 0.65-0.75.

In the cumulative distribution curve of sphericity area of the first particles in the section along the thickness direction of the electrode plate in the first region close to the current collector, the median of sphericity is within the above range, which is conducive to further reducing the stress concentration caused in the cutting process of the thick-coated film layer.

In some embodiments, in the cumulative distribution curve of sphericity area of the particles with the particle size R1 meeting 1 μm≤R1≤5 μm in the section along the thickness direction of the electrode plate in the first region, the median L_{R1A2}50 of sphericity is 0.67-0.75.

The median L_{R1A2}50 of sphericity of the particles with a particle size R1 meeting 1 μm≤R1≤5 μm in the first region is within above range, so that the stress concentration between the positive electrode film layer and the current collector can be further relieved, and the cycle life of the battery cell is prolonged.

In some embodiments, in a cumulative distribution curve of C value of degree of graphitization of the positive electrode film layer obtained in a surface scanning mode of a laser microscopic confocal Raman spectrometer, the median C₅₀ of the degree of graphitization is greater than or equal to 0.95 and less than or equal to 1.20, in which, the C value of the degree of graphitization is I_{G}/I_{D}, I_{G} indicates an intensity of a G band of a Raman spectrum at 1580±100 cm⁻¹, and Ip indicates the intensity of a D band of the Raman spectrum at 1350±100 cm⁻¹.

In the present application, the C value of the degree of graphitization of the positive electrode film layer can be obtained by the laser microscopic confocal Raman spectrometer in the surface scanning mode. As an example, specifically, the laser microscopic confocal Raman spectrometer (high-precision Renishaw laser microscopic confocal Raman spectrometer) is adopted, an excitation wavelength of 532 nm is selected, a proper amount of positive electrode film layer is taken for surface scanning on the surface or the section along the thickness direction of the electrode plate, the scanning area is 45 μm×45 μm, 10×10 grids are divided, grid vertexes are taken as test points, the step length is 5 μm, and there are totally 100 scanning points. Therefore, the C value of different sites and a cumulative distribution curve of C value in the surface scanning area are obtained.

In the present application, the positive electrode film layer can be a newly prepared positive electrode film layer, or a positive electrode film layer disassembled from the battery. The surface of the positive electrode film layer disassembled from the battery inevitably has residual electrolyte salt particles. In order to improve the test accuracy, surface scanning is preferably performed on the section of the positive electrode film layer along the thickness direction of the electrode plate, so as to represent the degree of graphitization of the positive electrode film layer.

The C value of the degree of graphitization of the positive electrode film layer is obtained through a band intensity ratio of a G band (G-band) to a D band (D-band) of a Raman spectrum, the position of the G band is 1580±100 cm⁻¹, which represents a carbon sp² hybrid structure. The position of the D band is 1350-100 cm⁻¹, which represents a disordered structure of carbon, and the disordered structure represents that there is no regular arrangement manner between carbon atoms in the structure.

The cumulative distribution curve of C value of the degree of graphitization is a curve obtained by arranging at least 100 obtained C values in an ascending sequence, taking the degree of graphitization as a horizontal axis and taking a cumulative number proportion as a vertical axis. C₅₀ is a corresponding C value at which the cumulative number proportion of the vertical axis in the cumulative distribution curve of C value of the degree of graphitization is 50%. Compared with a point value, the median C₅₀ of the degree of graphitization can reflect the overall degree of graphitization of the particles in the positive electrode film layer, namely an easy slippage degree. Compared with a mean value, the influence of the extreme value in the test process can be reduced, and the confidence coefficient of the test result is improved.

Those skilled in the art can implement the regulation to the degree of graphitization of the active material particles by any known method. As an example, the degree of graphitization of active material particles can be adjusted by adjusting and controlling the carbon source, the sintering temperature, the sintering time, the sintering pressure, and the sintering atmosphere.

In some embodiments, in the cumulative distribution curve of C value of degree of graphitization of the positive electrode film layer obtained in the surface scanning mode of the laser microscopic confocal Raman spectrometer, the median C₅₀ of the degree of graphitization is optionally 0.95, 0.96, 0.97, 0.98, 0.99, 1.0, 1.01, 1.02, 1.03, 1.04, 1.05, 1.06, 1.07, 1.08, 1.09, 1.1, 1.11, 1.12, 1.13, 1.14, 1.15, 1.16, 1.17, 1.18, 1.19, 1.20 or a numerical range between any two of them.

In the cumulative distribution curve of C value of degree of graphitization of the positive electrode film layer obtained in the surface scanning mode of the laser microscopic confocal Raman spectrometer, the median C₅₀ of the degree of graphitization is within above range, so that the compacted density of the electrode plate can be further improved, the content of first particles in the positive electrode film layer and the thickness of the positive electrode film layer can be reduced, which is conducive to further reducing the demolding probability of the positive electrode film layer on the basis of keeping the energy density of the battery.

In some embodiments, the porosity of the positive electrode film layer is 14%-28%.

The porosity of the positive electrode film layer can be tested in the following manner. The scanning electron micrograph of the section of the positive electrode film layer along the thickness direction of the electrode plate obtained according to the above method is imported into the ImageJ software, a linear tool is selected, the scale length in the micrograph is marked with a straight line, an “Analyze Set Scale” is clicked, and scale parameters are set in the software according to the scale length in the micrograph. A rectangular tool is selected, a micrograph part outside the scale area is selected, the selected area is duplicated with “Image Duplicate”, and the micrograph format is adjusted with “Image Type 8 bit”; the “Analyze Set Measurements” is selected, and the following five items are selected: “Area”, “Mean gray value”, “Area Fraction”, “Limit to threshold”, “Feret's diameter”, in which, it selects 3 in the “Decimal places”, “Image”-“Adjust”-“Threshold” is sequentially selected, 0 and 100 are sequentially set at the framed position of “Threshold”, and then, the pore data in the electron micrograph of the section can be exported by the Analyze-Measure function. The “Image”-“Overlay”-“Flatten” is clicked to export the pore image; and “Apply” in “Threshold” is clicked, then “Analyze”-“Analyze Particles” is clicked, and four columns at the left are ticked to obtain the pore statistical data.

It is to be understood that “pore” in the section of the positive electrode film layer is identified through image chromatic aberration and threshold in this embodiment of the present application. The “pore” is not pore data obtained in the exhaust test, it is mainly used for representing the sectional area among the particles in the section of the positive electrode film layer; and this method is superior to the exhaust method because the porosity obtained by the exhaust method is related to the pores among the particles and is also related to pores in carbon material on the surfaces of lithium-containing iron phosphate, the pores among the particles cannot be objectively reflected.

The porosity of the positive electrode film layer is within the above range, which is conducive to improving the liquid retention characteristic of electrolyte solution, improving the ion diffusivity of the thick-coated electrode plate and the positive electrode film layer containing a certain amount of first particles, thereby improving the dynamics performance of the battery.

In some embodiments, the porosity of the positive electrode film layer is optionally 14%, 15%, 16%, 17%, 18%, 19%, 20%, 21%, 22%, 23%, 24%, 25%, 26%, 27%, 28% or a numerical range between any two of them.

In some embodiments, the positive electrode film layer is provided with a primer in a bottom region close to the positive electrode current collector; and the primer includes a conductive agent and a binder, in which, the conductive agent includes carbon nanotubes and conductive carbon black, and the binder includes a vinylidene fluoride polymer.

In some embodiments, the thickness of the primer is 0.5-5 μm.

In some embodiments, the thickness of the primer is optionally 0.5 μm, 1 μm, 1.5 μm, 2 μm, 2.5 μm, 3 μm, 3.5 μm, 4 μm, 4.5 μm, 5 μm or a numerical range between any two of them.

According to the embodiment of the present application, with adoption of the primer, the particle size of particles at a part in direct contact with the current collector can be reduced, thus the stress concentration of the current collector at a die cutting position is reduced, the extrusion effect of the first particles in the positive electrode film layer on the current collector in the die cutting process is reduced, and the risk of aluminum leakage of the thick-coated electrode plate in the die cutting process is reduced; and moreover, the impedance of the thick-coated electrode plate is reduced, and the dynamics performance of the battery is improved.

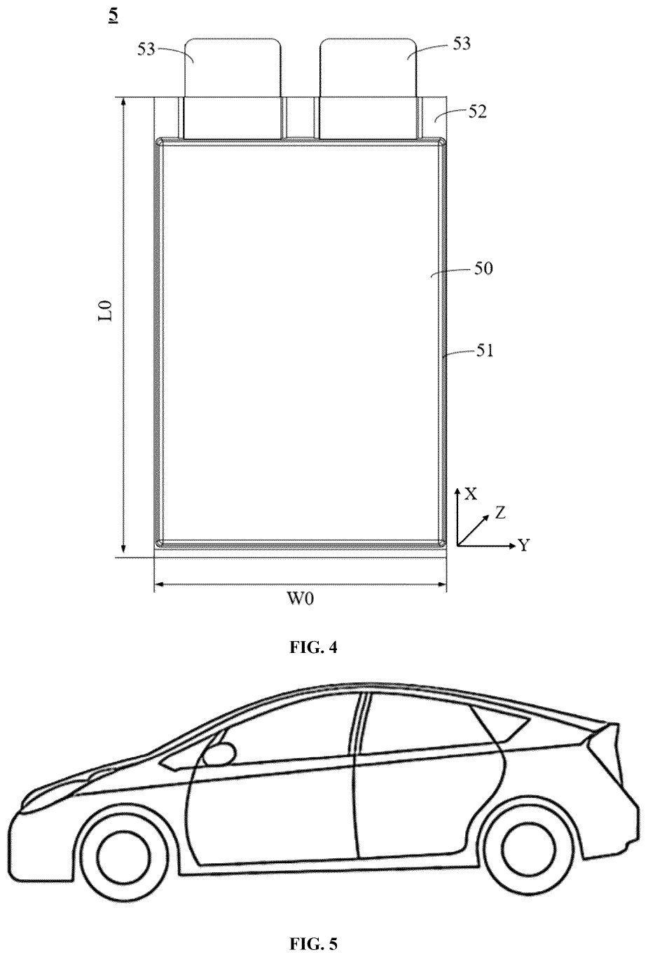

In some embodiments, as shown in FIG. 4, the battery cell 5 includes a case 50 in which the stacked electrode assembly is accommodated; the size of the case 50 in a length direction (X direction) is L0, the size of the case in a width direction (Y direction) is W0, the size of the case in a thickness direction (Z direction) is H0, 450 mm≤L0≤1300 mm, 100 mm≤W0≤150 mm, and 14 mm<H0≤22 mm.

In some embodiments, L0 is optionally, 450 mm, 460 mm, 470 mm, 480 mm, 490 mm, 500 mm, 510 mm, 520 mm, 530 mm, 540 mm, 550 mm, 560 mm, 570 mm, 580 mm, 590 mm, 600 mm, 610 mm, 620 mm, 630 mm, 640 mm, 650 mm, 660 mm, 670 mm, 680 mm, 690 mm, 700 mm, 710 mm, 720 mm, 750 mm, 800 mm, 850 mm, 900 mm, 950 mm, 1,000 mm, 1,050 mm, 1,100 mm, 1,150 mm, 1,200 mm, 1,250 mm, 1,300 mm or a numerical range between any two of them.

In some embodiments, W0 is optionally 100 mm, 110 mm, 120 mm, 130 mm, 140 mm, 150 mm or a numerical range between any two of them.

In some embodiments, H0 is optionally 14 mm, 15 mm, 16 mm, 17 mm, 18 mm, 19 mm, 20 mm, 21 mm, 22 mm or a numerical range between any two of them.

According to the embodiment of the present application, the size of the case of the battery cell is within the above range, which facilitates the battery to achieve relatively good capacity.

In some embodiments, the size L0 of the case in the length direction meets: 450 mm≤L0≤650 mm.

When the size L0 of the case in the length direction meets: 450 mm≤L0≤650 mm, the battery cell has a relatively short length, which is conducive to shortening the electron transmission path, reducing the internal resistance of the battery, shortening an infiltration distance of the electrolyte solution in an electrode pore, improving the infiltration uniformity, and improving the dynamics performance of the thick-coated electrode plate; and particularly, the phenomena of uneven temperature rise and uneven current density in the length direction of the electrode plate can be reduced under a fast charge condition.

In some embodiments, the size L0 of the case in the length direction meets: 900 mm≤L0≤1300 mm.

When the size L0 of the case in the length direction meets: 900 mm≤L0≤1300 mm, a traditional module structure can be effectively simplified by the greatly increased cell size, and the battery cell can be directly integrated into a battery pack; the battery is fixed by a structural member arranged at the end part of a large surface, thus the space utilization rate is significantly improved, furthermore, the overall capacity of a battery system is increased under the same volume; and moreover, the quantity of the structural members is reduced, and the energy density of the battery is improved.

In some embodiments, as shown in FIG. 4, the material of the case 50 is a pouch material which includes an aluminum-plastic composite film, optionally, a composite film formed by one or more of Polypropylene (PP), Polybutylene terephthalate (PBT), Polybutylene succinate (PBS), nylon, Polyethylene terephthalate (PET) and Polyethylene (PE), and aluminum.

The applicant found that compared with hard case materials such as an aluminum case and a steel case, the pouch material is light in weight, which is conducive to improving the energy density of a lithium-containing transition metal phosphate battery, thereby improving the capacity of the battery cell.

In some embodiments, with reference to FIG. 4, the case 50 includes a first sealing region 51 which is disposed on at least one end, extending along a width direction (Y direction), of the stacked electrode assembly; the first sealing region 51 includes an edge folding structure extending along a length direction (X direction); and a package adhesive is disposed on the edge folding structure, is continuously arranged along the length direction (X direction) and is used for fixing the edge folding structure.

The edge folding edge structure refers to a reinforcing structure formed by symmetrically folding a packaging area, the edge folding times are not limited, and as an example, it can be a single edge folding structure that is symmetrically folded once, or a double edge folding structure that is symmetrically folded twice.

The SEI film is greatly thickened in the cycle process of the electrode plate with the thick-coated film layer, so high rebound and gas production will occur in the long cycle process. The sealing region of the pouch cell is used for sealing the electrode assembly, but the strength of the sealing region is limited, and the risk that the sealing region is burst open by large rebound and high-yield gas in the thick-coated film layer may occur.

According to the embodiment of the present application, the sealing strength of the first sealing region is further improved by the edge folding structure extending along the length direction in the first sealing region. The package adhesive is continuously arranged along the length direction and is used for fixing the edge folding structure, which further improves the package strength compared with discontinuous arrangement of the package adhesive along the length direction, thus continuous reinforcement along the length direction of the sealing region is achieved, and the probability that the thick-coated pole plate breaks through the sealing region in a package during the cycle process is reduced.

In some embodiments, the case includes at least one second sealing region which is disposed on at least one end, extending along the length direction of the case, of the stacked electrode assembly; and the second sealing region is disposed on a tab side of the stacked electrode assembly.

It is to be understood that a positive electrode tab and a negative electrode tab can be disposed on the same side of the stacked electrode assembly, as shown in FIG. 4, and can also be disposed on the different sides of the stacked electrode assembly.

In some embodiments, the battery cell 5 further includes a lead-out member 53 which is connected to the tabs of the battery cell, for example, the lead-out member 53 can be connected to the tabs in a welding manner, the lead-out member 53 is a conductive member, at least part of the lead-out member 53 is positioned outside the case 50, the lead-out member 53 is used as an electrode lead-out end of the battery cell 5, and the lead-out member 53 facilitates the electrical connection between the battery cell 5 and other battery cells 5 or other parts. For example, the lead-out member 53 can be in a sheet shape.

Correspondingly, the lead-out member 53 also includes a positive electrode lead-out member and a negative electrode lead-out member, the positive electrode lead-out member is connected to the positive electrode tab, and the negative electrode lead-out member is connected to the negative electrode tab.

In some embodiments, the second sealing region is arranged at the tab side of the stacked electrode assembly, the tab is needed to be connected to a lead-out member, the connection strength of the lead-out member and the case material is relatively weak, so that gas is easy to rush out from the joint to result in a weak point easy to relieve pressure, which is conducive to directional pressure relief of the battery, thus reducing the influence on an adjacent cell during thermal runaway, and prolonging the service lifetime of the whole battery.

In some embodiments, a plurality of rubber rings surrounding along the width direction are arranged at the periphery of the stacked electrode assembly and are arranged at intervals along the length direction.

The rubber rings surrounding along the width direction of the cell are arranged at intervals in the length direction, which is conducive to fixing the position of electrode plates in the cell, and reducing the probability of displacement of the cell in the shaking process of the battery; it is particularly suitable for batteries with a relatively large length, the phenomenon of lithium precipitation caused by mutual displacement of the electrode plates in the length direction can be effectively reduced, and the stability of a space structure in the battery is favorably kept, so that the normal operation of the battery is not influenced.

In some embodiments, at 25 °C, the capacity of the battery cell is 100-300 Ah, optionally, 110-190 Ah, further optionally, 125-180 Ah.

In the present application, the capacity of the battery cell is known in the field and can be tested by the method known in the field. As an example, at 25 °C, the battery cell is charged to be 3.65V at a charging rate of 0.5 C of the nominal capacity of the battery cell, then is charged to 0.05 C at a constant voltage of 3.65V, stands for 10 min, then is discharged to 2.5V at a discharging rate of 1 C, and stands for 10 min; and the capacity C in the discharging process is calculated with a formula C=I*t, followed by the unit of Ah.

In some embodiments, at 25 °C, the capacity of the battery cell is optionally, 100 Ah, 110 Ah, 125 Ah, 128 Ah, 130 Ah, 135 Ah, 140 Ah, 145 Ah, 150 Ah, 155 Ah, 159 Ah, 160 Ah, 161 Ah, 162 Ah, 165 Ah, 170 Ah, 175 Ah, 177 Ah, 180 Ah, 185 Ah, 190 Ah, 300 Ah or a numerical range between any two of them.

According to the battery cell provided by the embodiment of the present application, the stacked electrode assembly is accommodated in the care with a proper size, a reasonable large particle proportion in the film layer of the positive electrode plate in the stacked electrode assembly is controlled, so that the battery cell has relatively high capacity.

In some embodiments, the positive electrode current collector can be a metal foil or a composite current collector. For example, if it is the metal foil, an aluminum foil can be adopted. The composite current collector may include a polymer material substrate and a metal layer formed on at least one surface of the polymer material substrate. The composite current collector can be formed by forming a metal material (aluminum, aluminum alloy, nickel alloy, titanium, titanium alloy, silver, silver alloy and the like) on a polymer material substrate material (such as polypropylene (PP), polyethylene glycol terephthalate (PET), polybutylene terephthalate (PBT), Polystyrene (PS), Polyethylene (PE) and the like).

In some embodiments, the negative electrode current collector can be a metal foil or a composite current collector. For example, as the metal foil, a copper foil can be used. The composite current collector may include a polymer base layer and a metal layer formed on at least one surface of the polymer substrate. The composite current collector can be formed by forming a metal material (copper, copper alloy, nickel, nickel alloy, titanium, titanium alloy, silver, silver alloy and the like) on a polymer material substrate (polypropylene (PP), polyethylene terephthalate (PET), polybutylene terephthalate (PBT), Polystyrene (PS), Polyethylene (PE) and the like).

In some embodiments, the negative electrode film layer includes a negative electrode material. As an example, the negative electrode active material can include at least one of the following materials: artificial graphite, natural graphite, soft carbon, and hard carbon. The present application is not limited to these materials, and other traditional materials which can be used as the negative electrode active material of the battery can also be used. These negative electrode active materials may be used alone or in a combination of two or more thereof.

In some embodiments, the negative electrode film layer further optionally comprises a binder. The binder may be selected from at least one of styrene butadiene rubber (SBR), polyacrylic acid (PAA), sodium polyacrylate (PAAS), polyacrylamide (PAM), polyvinyl alcohol (PVA), sodium alginate (SA), polymethacrylic acid (PMAA), and carboxymethyl chitosan (CMCS).

In some embodiments, the negative electrode film layer further optionally comprises a conductive agent. The conductive agent may be selected from at least one of superconducting carbon, acetylene black, carbon black, Ketjen black, carbon dot, carbon nanotube, graphene, and carbon nanofiber.

In some embodiments, the negative electrode material also optionally includes other auxiliaries, such as a thickening agent (such as sodium carboxymethylcellulose (CMC-Na)).

In a second aspect, the present application provides a battery apparatus, which includes the battery cell provided by the present application in the first aspect.

The electrical apparatus disclosed by the embodiment of the present application can be used in an electrical apparatus using the battery apparatus as a power source or various energy storage systems using the battery apparatus as an energy storage element. The electrical apparatus can be used in vehicles, or other but not limited to mobile phones, tablet computers, notebook computers, electric toys, electric tools, electric vehicles, electric automobiles, ships, spacecraft and the like. The electric toys can include a fixed or mobile electric toy, such as a game machine, an electric automobile toy, an electric ship toy and an electric aircraft toy, and the spacecraft can include an aircraft, a rocket, a space shuttle, a spacecraft and the like.

In addition, the present application further provides an electrical apparatus using the battery apparatus as a power source, which includes at least one of the battery cell, the battery module, or the battery pack provided by the present application. The battery cell, the battery module or the battery pack can be used as the power source for the electric device and can also be used as an energy storage unit for the electrical apparatus.

For the electrical apparatus, the battery cell, the battery module or the battery can be selected according to the use requirements.

FIG. 5 shows an electrical apparatus taken as an example. The electrical apparatus disclosed by the embodiment of the present application may be a fuel vehicle, a gas vehicle or a new energy vehicle, and the new energy vehicle may be a pure electric vehicle, a hybrid electric vehicle or an extended-range vehicle and the like. A battery apparatus is arranged in the vehicle, and the battery apparatus can be arranged at the bottom or head or tail of the vehicle. The battery apparatus may be used for supplying power to the vehicle, for example, the battery apparatus may serve as an operation power source of the vehicle. The vehicle can further include a controller and a motor, and the controller is configured to control the battery apparatus to supply power to the motor, for example, the controller is configured to meet the working power consumption requirements of the vehicle in starting, navigation and driving. In some embodiments of the present application, the battery apparatus can be used as an operation power supply of the vehicle, can also be used as a driving power supply of the vehicle, and replaces or partially replaces fuel oil or natural gas to provide driving power for the vehicle.

An embodiment of the present application also provides an energy storage apparatus using the battery apparatus as a power source; and the energy storage apparatus can be, but not limited to, an energy storage container, an energy storage cabinet, an energy storage power station, an energy storage battery pack or a portable energy storage system and the like.

### EXAMPLES

Examples of the present application will be described below. The Examples described below are illustrative and only used to explain the present application, and cannot be construed as limiting the present application. In Examples in which no specific technologies or conditions are specified, technologies or conditions described in the literature in the art or product specifications are followed. The reagents or instruments used without manufacturer indicated are all commercially available conventional products.

### Example 1

### (1) Preparation of Positive Electrode Active Material

Lithium carbonate, iron phosphate, titanium dioxide, vanadium pentoxide, sucrose, glucose and polyethylene glycol were added to de-ionized water and mixed in a pre-mixing tank, in which, the molar ratio of lithium to iron was 1.02:1.0 based on the ratio of the lithium carbonate to the iron phosphate; based on the total mass of mixed raw materials, the mass content of the sucrose was 2%, the mass content of the glucose was 4%, and the mass content of the polyethylene glycol was 5%; after uniformly mixing, the mixed raw materials with the solid content of 38% was obtained;
the particle size Dv₅₀ of the lithium carbonate was 6 μm; the shape of iron phosphate particles was similar to a sphere; the titanium dioxide and the vanadium pentoxide were nano-particles; the purity of the sucrose was more than or equal to 98%; the water mass content of the glucose was less than 0.5%; and the weight-average molecular weight of the polyethylene glycol was 1, 500.

The mixed raw materials were ground twice by a sand mill; after roughly grinding for 1 h, fine grinding was performed, the temperature of slurry was controlled to be less than 40 °C in the grinding process, and mixed slurry was obtained; the particle size Dv50 of solid particles in the mixed slurry was 0.40 μm; spray drying was carried out to obtain dried precursor powder, and the particle size Dv50 of the dried precursor powder was 55.50 μm.

Two-section type temperature-rise sintering was performed on the precursor powder in a nitrogen atmosphere to obtain the positive electrode active material: the temperature was raised from 25 °C to 460 °C (a first temperature rise section) at a temperature rise rate of 2 °C/min, and the temperature was maintained for 3 h; the temperature was raised from 460 °C to 780 °C. (a second temperature rise section) at a temperature rise rate of 5 °C/min, and the temperature was maintained for 12 h; the ventilation amount in the temperature rise section was greater than that in a constant-temperature section and the ratio was 1.5:1; the total ventilation amount was 1350 cm³/h, and finally, temperature decrease was carried out; airflow crushing was performed to obtain a lithium iron phosphate positive electrode active material with the particle size Dv50 of 1.6 μm and a carbon material on the surface, in which, based on the total mass of the positive electrode active material, the mass content of a Ti element was 1050 ppm, and the mass content of a V element was 950 ppm.

The Dv10, the Dv50 and the Dv90 were data obtained by test using a Markovian laser scattering method.

### (2) Preparation of Positive Electrode Plate

93.9% by mass of the positive electrode active material, 2% by mass of a conductive agent and 3% by mass of a binder that was polyvinylidene fluoride were mixed in a solvent that was N-methyl pyrrolidone, then 1.1% by mass of a dispersant that was HNBR was added, and all the materials were fully mixed in a stirring tank, stirred, and then dispersed to obtain positive electrode slurry; after the stirring process, the positive electrode slurry was conveyed to a coating process; the mass proportion of the positive electrode active material, the conductive agent, the binder and the dispersant was calculated based on the total mass of solids in the positive electrode slurry; the conductive agent included 1.33% by mass of conductive carbon black and 0.67% by mass of a single-walled carbon nanotube; the specific surface area of the conductive carbon black was 85 m²/g, and the oil absorption value was 200 ml/100 g; the average length of the single-walled carbon nanotubes was 30 μm, and the specific surface area was 300 m²/g; the mass content of metal impurities in the single-walled carbon nanotube was less than 1 wt %;

The positive electrode slurry was transferred and coated onto an aluminum foil of a current collector for roasting; and hot pressing was performed to obtain the positive electrode plate of which the single-side thickness of a positive electrode film layer was 105.64 μm and the compacted density was 2.36 g/cm³. The transferring and coating speed was 20 m/min.

The hot pressing process included three times of hot rolling, the hot rolling pressures were sequentially increased as 40 tons, 60 tons and 80 tons. The hot rolling temperature was 60 °C, and the electrode plate was heated at 40 °C before the first hot rolling compaction.

The compacted density herein refers to the compacted density of the battery cell in a full-discharge state, and the test method is shown as follows.

The median C₅₀ of degree of graphitization of the positive electrode film layer was 1.005, and the porosity of the positive electrode film layer was 16.1%.

The positive electrode plate was slit and punched into a specified shape, and the punched positive electrode plate was graded according to weight by a sorting and weighing machine, so as to be laminated by a laminating machine.

### (3) Preparation of Negative Electrode Plate

Natural graphite, a conductive agent that was conductive carbon black, a binder that was Styrene Butadiene Rubber (SBR) and a thickener that was sodium carboxymethyl cellulose (CMC) were uniformly mixed according to the weight percentage of 95:1:2:2, then deionized water was added, and all materials were stirred and dispersed to obtain negative pole slurry; and a substrate copper foil was coated with the negative pole slurry, and then subjected to drying, compacting, slitting and tabletting to obtain the negative electrode plate.

The negative electrode plate was slit and punched into a specified shape, and the punched negative electrode plate was graded according to weight by a sorting and weighing machine, so as to be laminated by a laminating machine.

### (4) Separator

Polyvinylidene fluoride (PVDF) was dissolved in N-methyl pyrrolidone (NMP), and uniformly stirred; polyethylene glycol (PEG) was added as a pore-forming agent, and fully stirred and mixed to obtain a binding layer solution. A base film with ceramic layers on both sides was coated with the binding layer solution; after pre-volatilizing at 80 °C and drying at 110 °C, the base film was immersed in deionized water to dissolve out PEG so as to obtain a separator with the binding layers of porous structures on both sides. The thickness of the base film was 8 μm, the thickness of the ceramic layer on one side was 3 μm, and the thickness of the binding layer on one side was 1 μm.

### (5) Electrolyte Solution

In an argon atmosphere glove box (H₂O<0.1 ppm, O₂<0.1 ppm), organic solvents that were dimethyl carbonate (DMC), Ethyl Methyl Carbonate (EMC) and Ethylene Carbonate (EC) were uniformly mixed.

Then lithium hexafluorophosphate was added and dissolved in the organic solvents to make the concentration of lithium hexafluorophosphate be 1.05 mol/L, and Vinylene Carbonate (VC) was added, and uniformly stirred to obtain the electrolyte solution in Example 1.

Based on the total mass of the electrolyte, the mass content of dimethyl carbonate was 26%, the mass content of ethyl methyl carbonate was 43.3%, the mass content of ethylene carbonate was 17.3%, and the mass content of vinylene carbonate was 0.9%.

### (6) Preparation of Battery

The positive electrode plate, the separator and the negative electrode plate were laminated by a laminating machine to obtain a stacked electrode assembly, and the separator could play a role in separating a positive electrode from a negative electrode. The stacked electrode assembly was glued until being tightly wrapped. The glued stacked electrode assembly was placed in an outer package, and the outer package was a pouch material aluminum-plastic film which was formed by compositing inner-layer polypropylene, middle-layer aluminum foil and outer-layer nylon. The aluminum-plastic film outer package was formed by a punching molding machine and trimmed to obtain a target shape and a target size. Then the aluminum-plastic film was thermally packaged to meet the requirement that the packaging tension of the aluminum-plastic film was more than or equal to 25 N/8 mm. The battery was roasted in vacuum, stood, injected with an electrolyte solution, and packaged; and then the pouch battery was subjected to hot pressing and cold pressing operation, the hot pressing was performed for 2 min at 45 °C under pressure of 90 kg/cm², the cold pressing was performed for 2 min at 25 °C under pressure of 90 kg/cm². Finally, the processes of formation, vacuumizing, exhausting, trimming and the like were carried out to obtain the battery cell. The size of the battery cell in the length direction was 600 mm, the size of the battery cell in the width direction was 125 mm, and the size of the battery cell in the thickness direction was 20 mm.

Preparation methods in Examples 2-5 were basically the same as that in the Example 1, and the difference was that preparation methods for a positive electrode active material and a positive electrode plate are adjusted, specifically:

### Example 2

(2) Preparation of a positive electrode active material: uniformly mixing lithium dihydrogen phosphate, ferrous oxalate, polyethylene glycol with the weight-average molecular weight of 1000, polyethylene glycol with the weight-average molecular weight of 1500, titanium dioxide and vanadium pentoxide in methanol, and grinding to obtain a mixed raw material. The molar ratio of lithium to iron was 1.02:1.0 based on the ratio of lithium dihydrogen phosphate to ferrous oxalate. The particle size D₁₀ of ferrous oxalate was 6.2 μm, the particle size D₅₀ of ferrous oxalate was 60.8 μm, the particle size D₉₀ of ferrous oxalate was 106.5 μm, the mass content of Fe an element in ferrous oxalate was 30.6%, and the mass content of a ferric element in ferrous oxalate was 0.03%.

The mixed raw materials were subjected to ball milling by a ball mill for a plurality of times, and demagnetized to obtain mixed slurry. The grinding times and time were controlled, and the particle size Dv₅₀ of the ground mixed slurry was 3.1 μm.

Spray drying was performed on the mixed slurry to obtain dried precursor powder, and the dried precursor powder was light yellow in appearance and uniform in color.

The precursor powder was put into a sintering furnace and heated from 25 °C to 360 °C at a speed of 2 °C/min in a nitrogen atmosphere, and was subjected to temperature maintaining for 3.5 h at this temperature, and then, the precursor powder was heated to reach a second temperature of 775 °C at a speed of 5 °C/min, and subjected to temperature maintaining for 10 h at this temperature, and then cooled. Based on the total mass of the positive electrode active material, the mass content of a Ti element was 1,050 ppm, and the mass content of a V element was 950 ppm.

The obtained material was crushed by an airflow crushing method at the air volume with the grading frequency of 22 Hz and the crushing air pressure of 0.55 MPa, and the lithium iron phosphate positive electrode active material with the carbon material on the surface was obtained.

The D10, D50, D90 and Dv50 were data obtained by test using the Malvern laser scattering method.

### (2) Preparation of Positive Electrode Plate

93.9% by mass of the positive electrode active material, 2% by mass of the conductive agent and 3% by mass of the binder that was polyvinylidene fluoride were mixed in a solvent that was N-methyl pyrrolidone, then 1.1% by mass of a dispersant that was HNBR was added, and all the materials were fully mixing in a stirring tank, stirred, and dispersed to obtain positive electrode slurry; after the stirring process, the positive electrode slurry was conveyed to a coating process; the mass proportion of the positive electrode active material, the conductive agent, the binder and the dispersant was calculated based on the total mass of solids in the positive electrode slurry; the conductive agent included 1.33% by mass of conductive carbon black and 0.67% by mass of single-walled carbon nanotube; the specific surface area of the conductive carbon black was 85 m²/g, and the oil absorption value was 200 ml/100 g; the average length of the single-walled carbon nanotube was 30 μm, and the specific surface area was 300 m²/g; the mass content of metal impurities in the single-walled carbon nanotube was less than 1 wt %;

The positive electrode slurry was transferred and coated onto an aluminum foil of a current collector for roasting; and hot pressing was carried out to obtain the positive electrode plate of which the single-side thickness of a positive electrode film layer was 105.89 μm and the compacted density was 2.36 g/cm³. The stirring included pre-stirring and main stirring, the stirring speed of the pre-stirring was lower than that of the main stirring, the revolution speed of the pre-stirring was 25 rpm, and the autorotation speed was 500 rpm; and the pre-stirring was performed for 15 min.

The hot pressing process included three times of hot rolling, the hot rolling pressures were sequentially increased as 35 tons, 55 tons and 75 tons. The hot rolling temperature was 65 °C, and the electrode plate was heated at 50 °C before the first hot rolling compaction. The compacted density herein refers to the compacted density of the battery cell in a full-discharge state, and the test method is shown as follows.

The positive electrode plate was slit and punched into a specified shape, and the punched positive electrode plate was graded according to weight by a sorting and weighing machine, so as to be laminated by a laminating machine.

### Example 3

### (3) Preparation of Positive Electrode Active Material

Lithium carbonate, iron phosphate, sucrose, glucose, titanium dioxide and vanadium pentoxide were added to water and mixed in a pre-mixing tank under the rotary speed of 1,800 rpm, in which, the molar ratio of iron to phosphorus was 0.975 based on the ratio of the lithium carbonate to the iron phosphate, the mass content of the glucose was 3.8% relative to the iron phosphate and the mass content of the sucrose was 1.9% relative to the iron phosphate;
the mixed raw materials were ground twice by a sand mill; first grinding was carried out by a zirconium oxide ball with the diameter of 0.6 mm at a rotary speed of 500 rpm, the grinding was performed for 1 h, and the pressure of a grinding chamber was less than 0.3 MPa; then second grinding was carried out to obtain mixed slurry, and the particle size Dv₅₀ of the mixed slurry was 0.43 μm; and
spray drying was carried out on the mixed slurry to obtain precursor powder,

The precursor powder was sintered to obtain a lithium iron phosphate positive electrode material, and the sintering process included:
first sintering: the precursor powder was sintered in a nitrogen atmosphere, subjected to temperature rise from 25 °C to 765 °C at a temperature rise rate of 5 °C/min, maintained at the temperature for 10 h, and then cooled to obtain a first sintered product;
grinding and mixing: sucrose accounting for 0.5% of the total mass of the first sintered product, glucose accounting for 1% of the total mass of the first sintered product and polyethylene glycol accounting for 3.0% of the total mass of the first sintered product were added to the first sintered product; grinding was performed in two groups (third grinding), grinding is stopped when the Dv₅₀ of particles in the first group reached 1.0 μm (grinding condition: 550 rpm, and the grinding time: 1 h) so as to obtain a first group of ground products; grinding was stopped when the Dv₅₀ of particles in the second group reached 0.40 μm (grinding condition: 500 rpm, and grinding time: 4 h) so as to obtain a second group of ground products; the first group of ground products and the second group of ground products were mixed according to a mass ratio of 72:28 to obtain a mixed intermediate product; and spray drying was performed on the mixed intermediate product; and
second sintering: the dried mixed intermediate product was sintered in a nitrogen atmosphere, subjected to temperature rise from 25 °C to 800 °C at a temperature rise rate of 5 °C/min, maintained at the temperature for 10 h, and then cooled to obtain a second sintered product.

After being cooled to be 100 °C or below, and the second sintered product was crushed by an airflow crushing method, so as to obtain the lithium iron phosphate positive electrode active material with the carbon material on the surface, in which, the grading frequency of airflow crushing was 25 Hz, and the crushing air pressure was 0.55 MPa. Based on the total mass of the positive electrode active material, the mass content of Ti element was 1050 ppm, and the mass content of V element was 950 ppm.

### (2) Preparation of Positive Electrode Plate

93.9% by mass of the positive electrode active material, 2% by mass of the conductive agent and 3% by mass of the binder that was polyvinylidene fluoride were mixed in a solvent that was N-methyl pyrrolidone, then 1.1% by mass of a dispersant that was HNBR was added, and all the materials were fully mixing in a stirring tank, stirred, and dispersed to obtain positive electrode slurry; after the stirring process, the positive electrode slurry was conveyed to a coating process; the mass proportion of the positive electrode active material, the conductive agent, the binder and the dispersant was calculated based on the total mass of solids in the positive electrode slurry; the conductive agent included 1.33% by mass of conductive carbon black and 0.67% by mass of single-walled carbon nanotube; the specific surface area of the conductive carbon black was 85 m²/g, and the oil absorption value was 200 ml/100 g; the average length of the single-walled carbon nanotube was 30 μm, and the specific surface area was 300 m²/g; the mass content of metal impurities in the single-walled carbon nanotube was less than 1 wt %;
the positive electrode slurry was transferred and coated onto the aluminum foil of the current collector for roasting; and hot pressing was performed to obtain the positive electrode plate of which the single-side thickness of the positive electrode film layer was 106.21 μm and the compacted density was 2.37 g/cm³. The roasting temperature was 95 °C, and the speed was 2.0 m/min.

The hot pressing process included three times of hot rolling, the hot rolling pressures were sequentially increased as 35 tons, 55 tons and 75 tons. The hot rolling temperature was 65 °C, and the electrode plate was heated at 50 °C before the first hot rolling compaction. The compacted density herein refers to the compacted density of the battery cell in a full-discharge state, and the test method is shown as follows.

The positive electrode plate was slit and punched into a specified shape, and the punched positive electrode plate was graded according to weight by a sorting and weighing machine, so as to be laminated by a laminating machine.

### Example 4

A preparation method in the Example 4 was basically consistent with that in the Example 1, and the difference was slightly in the preparation process of the positive electrode active material and the hot-pressing process of the positive electrode plate, specifically,
(4) carbon sources in the mixed raw materials were sucrose and glucose, the mass of the sucrose was 2 wt % of the mass of iron phosphate, and the mass of the glucose was 4 wt % of the mass of the iron phosphate; and
(5) the temperature-rise sintering process was different. The precursor powder was sintered at least twice in a nitrogen atmosphere, the temperature for the first sintering was 765 °C, the temperature was maintained for 8 h, and then a primarily sintered product was obtained.

1.5 wt % (based on the mass of the primarily sintered product) of glucose, 3.0 wt % (based on the mass of the primarily sintered product) of polyethylene glycol, titanium dioxide and vanadium pentoxide were added to the primarily sintered product, and uniformly ground and then divided into two groups for secondary grinding. The grinding parameters of the two groups were different, the Dv50 of the ground particles in the first group was controlled to be 2.2 μm, and the Dv50 of the ground particles in the second group was controlled to be 0.4 μm. The ground particles in the first group and the second group were mixed according to a mass ratio of 30:70, spray drying was performed, and secondary sintering was carried out. The temperature for the secondary sintering was 815 °C, and the temperature was maintained for 10 h.

Based on the total mass of the positive electrode active material, the mass content of the Ti element was 1,050 ppm, and the mass content of the V element was 950 ppm.

(3) The positive electrode slurry was transferred and coated onto the aluminum foil of the current collector for roasting; and hot pressing was carried out to obtain the positive electrode plate of which the single-side thickness was 106.34 μm and the compacted density was 2.37 g/cm³. The drying temperature was 95 °C, and the speed was 2.0 m/min.

The hot pressing process included three times of hot rolling, the hot rolling pressures were sequentially increased as 35 tons, 55 tons and 70 tons. The hot rolling temperature was 65 °C, and the electrode plate was heated at 50 °C before the first hot rolling compaction. The compacted density herein refers to the compacted density of the battery cell in a full-discharge state, and the test method is shown as follows.

### Example 5

A preparation method in the Example 5 was basically consistent with that in the Example 1, and the difference was in the sintering process of the positive electrode active material and the hot-pressing process of the positive electrode plate are different, specifically,
(6) the precursor powder was subjected to two-stage temperature-rise sintering on in a nitrogen atmosphere to obtain the positive electrode active material: the temperature was raised from 25 °C to 440 °C (a temperature rise stage) at a temperature rise rate of 2 °C/min, and the temperature was maintained for 2.5 h; the temperature was raised from 440 °C to 760 °C (a second temperature rise stage) at a temperature rise rate of 5 °C/min, and the temperature was maintained for 11 h; and then the airflow crushing strength was increased to obtain the lithium iron phosphate positive electrode active material with the carbon material on the surface.
(7) The positive electrode slurry was transferred and coated onto the aluminum foil of the current collector for drying; and hot pressing was carried out to obtain the positive electrode plate of which the single-side thickness was 105.65 μm and the compacted density was 2.36 g/cm³. The transferring and coating speed was 20 m/min.

The hot pressing process included three times of hot rolling, the hot rolling pressures were sequentially increased as 45 tons, 60 tons and 80 tons. The hot rolling temperature was 60 °C, and the electrode plate was heated at 40 °C before the first hot rolling compaction.

Preparation methods in Examples 6-10 were basically the same as that in the Example 1, and the difference was that the preparation method for the positive electrode plate was adjusted, specifically,

### Example 6

The positive electrode slurry in the Example 1 was transferred and coated onto the aluminum foil for the current collector for roasting; the pressure, calendering speed, roller gap, pressure maintaining time and calendering times in the hot-pressing process were adjusted, and the coating surface density was controlled, and then hot pressing was carried out to obtain the positive electrode plate of which the single-side thickness of the positive electrode film layer was 91.88 μm; the compacted density of the positive electrode plate was 2.36 g/cm³. The compacted density herein refers to the compacted density of the battery cell in a full-discharge state, and the test method is shown as follows. The number of laminated layers was kept unchanged, and the thickness of the battery cell was adaptively adjusted according to the thickness of the positive electrode film layer.

### Example 7

The positive electrode slurry in the Example 1 was transferred and coated onto the aluminum foil for the current collector for roasting; the pressure, calendering speed, roller gap, pressure maintaining time and calendering times in the hot-pressing process were adjusted, and the coating surface density was controlled, and then hot pressing was carried out to obtain the positive electrode plate of which the single-side thickness of the positive electrode film layer was 116.09 μm; the compacted density of the positive electrode plate was 2.36 g/cm³. The compacted density herein refers to the compacted density of the battery cell in a full-discharge state, and the test method is shown as follows. The number of laminated layers was kept unchanged, and the thickness of the battery cell was adaptively adjusted according to the thickness of the positive electrode film layer.

### Example 8

The positive electrode slurry in the Example 1 was transferred and coated onto the aluminum foil for the current collector for roasting; the pressure, calendering speed, roller gap, pressure maintaining time and calendering times in the hot-pressing process were adjusted, and the coating surface density was controlled, and then hot pressing was carried out to obtain the positive electrode plate of which the single-side thickness of the positive electrode film layer was 72.34 μm; the compacted density of the positive electrode plate was 2.36 g/cm³. The compacted density herein refers to the compacted density of the battery cell in a full-discharge state, and the test method is shown as follows. The number of laminated layers was kept unchanged, and the thickness of the battery cell was adaptively adjusted according to the thickness of the positive electrode film layer.

### Example 9

The positive electrode slurry in the Example 1 was transferred and coated onto the aluminum foil for the current collector for roasting; the pressure, calendering speed, roller gap, pressure maintaining time and calendering times in the hot-pressing process were adjusted, and the coating surface density was controlled, and then hot pressing was carried out to obtain the positive electrode plate of which the single-side thickness of the positive electrode film layer was 83.91 μm; the compacted density of the positive electrode plate was 2.36 g/cm³. The compacted density herein refers to the compacted density of the battery cell in a full-discharge state, and the test method is shown as follows. The number of laminated layers was kept unchanged, and the thickness of the battery cell was adaptively adjusted according to the thickness of the positive electrode film layer.

### Example 10

The positive electrode slurry in the Example 1 was transferred and coated onto the aluminum foil for the current collector for roasting; the pressure, calendering speed, roller gap, pressure maintaining time and calendering times in the hot-pressing process were adjusted, and the coating surface density was controlled, and then hot pressing was carried out to obtain the positive electrode plate of which the single-side thickness of the positive electrode film layer was 98.93 μm; the compacted density of the positive electrode plate was 2.52 g/cm³. The compacted density herein refers to the compacted density of the battery cell in a full-discharge state, and the test method is shown as follows. The number of laminated layers was kept unchanged, and the thickness of the battery cell was adaptively adjusted according to the thickness of the positive electrode film layer.

A preparation method in an Example 11 was basically the same as that in the Example 1, and the difference was that no dispersant was added in the preparation process of the positive electrode plate, specifically,

94.9% by mass of the positive electrode active material, 2.05% by mass of the conductive agent and 3.05% by mass of the binder that was polyvinylidene fluoride were mixed in a solvent that was N-methyl pyrrolidone, fully mixed in a stirring tank, stirred and dispersed to obtain positive electrode slurry; after the stirring process, the positive electrode slurry was conveyed to a coating process; and the mass proportion of the positive electrode active material, the conductive agent and the binder was calculated based on the total mass of solids in the positive electrode slurry.

A preparation method in a Contrast Example 1 was basically the same as that in the Example 1, and the difference was in the sintering process of the positive electrode active material, specifically,

### Contrast Example 1

The precursor powder was subjected to two-stage temperature-rise sintering in a nitrogen atmosphere to obtain the positive electrode active material: the temperature was raised from 25 °C to 500 °C (a temperature rise stage) at a temperature rise rate of 2 °C/min, and the temperature was maintained for 3.5 h; the temperature was raised from 500 °C to 800 °C (a second temperature rise stage) at a temperature rise rate of 5 °C/min, and the temperature was maintained for 13 h; and then the airflow crushing strength was increased to obtain the lithium iron phosphate positive electrode active material with the carbon material on the surface.

A preparation method in a Contrast Example 2 was basically the same as that in the Example 1, and the difference was that the preparation method of the positive electrode plate was adjusted, specifically,

### Contrast Example 2

The positive electrode slurry in the Example 1 was transferred and coated onto the aluminum foil for the current collector for drying; the pressure, calendering speed, roller gap, pressure maintaining time and calendering times in the hot-pressing process were adjusted, and the coating surface density was controlled, and then hot pressing was carried out to obtain the positive electrode plate of which the single-side thickness of the positive electrode film layer was 65.08 μm; the compacted density of the positive electrode plate was 2.36 g/cm³. The compacted density herein refers to the compacted density of the battery cell in a full-discharge state, and the test method is shown as follows. The number of laminated layers was kept unchanged, and the thickness of the battery cell was adaptively adjusted according to the thickness of the positive electrode film layer.

A preparation method in a Contrast Example 3 was basically the same as that in the Example 1, and the difference was that the preparation method of the positive electrode plate was adjusted, specifically,

The positive electrode slurry in the Contrast Example 1 was transferred and coated onto the aluminum foil for the current collector for drying; the pressure, calendering speed, roller gap, pressure maintaining time and calendering times in the hot-pressing process were adjusted, and the coating surface density was controlled, and then hot pressing was carried out to obtain the positive electrode plate of which the single-side thickness of the positive electrode film layer was 91.9 μm; the compacted density of the positive electrode plate was 2.36 g/cm³. The compacted density herein refers to the compacted density of the battery cell in a full-discharge state, and the test method is shown as follows. The number of laminated layers was kept unchanged, and the thickness of the battery cell was adaptively adjusted according to the thickness of the positive electrode film layer.

### Test Method

### 1. Capacity of Battery Cell

At 25 °C, the battery cell was charged to be 3.65 V at a charging rate of 0.5 C of the nominal capacity of the battery cell, then was charged to 0.05 C at a constant voltage of 3.65 V, stood for 10 min, then was discharged to 2.5 V at a discharging rate of 1 C, and stood for 10 min; and the capacity C in the discharging process was calculated with a formula C=I*t, followed by the unit of Ah.

2. Aluminum Leakage Ratio after Electrode Plate Cutting

The proportion of positive electrode plates with aluminum leakage phenomenon was tested by a method known in the field, and as an example, the following method could be carried out for testing: observing a certain amount of electrode plates after slitting and punching by a CCD, counting the frequency K1 of the electrode plates with aluminum leakage phenomenon, and calculating to obtain the proportion of the electrode plates with aluminum leakage phenomenon as K1/total number of electrode plates×100%, and there were totally 100 electrode plates.

### 3. Number of Cycles Corresponding to the Capacity Attenuated to 90%

At 25 °C, the battery cell was charged to be 3.65 V at a charging rate of 0.5 C of the nominal capacity of the battery cell, then was charged to 0.05 C at a constant voltage of 3.65 V, stood for 10 min, then was discharged to 2.5V at a discharging rate of 1 C, and stood for 10 min; performing charging and discharging once was treated as a cycle, testing was stopped until the battery capacity was attenuated to 90% of nominal capacity, and recorded as the number of cycles @90% SOH.

### Test Results

TABLE 1

| | Positive electrode plate | | | | | |
|---|---|---|---|---|---|---|
| | | | | When the | | |
| | | | | battery | | |
| | | | | cell is | | |
| | First region | | | in a full- | | |
| | | Median of | | discharge | | |
| | Area | sphericity of | | state, the | | |
| | proportion of | first particles | | compacted | | Aluminum |
| | first particles | with particle | Single-side | density | | leakage |
| | with particle | size R1 | thickness of | of the | | ratio |
| | size R1 | meeting | positive | positive | Capacity | after |
| | meeting | R1 ≥ | electrode | electrode | of | electrode |
| | R1 ≥ | 1000 nm | film layer | plate | battery | plate |
| | 1000 nm | L_{R1A150} | μm | g/cm³ | cell Ah | cutting |
| Example | 36.64% | 0.687 | 105.64 | 2.36 | 160 | 0% |
| 1 | | | | | | |
| Example | 34.78% | 0.673 | 105.89 | 2.36 | 162 | 0% |
| 2 | | | | | | |
| Example | 34.95% | 0.745 | 106.21 | 2.37 | 162 | 0% |
| 3 | | | | | | |
| Example | 49.96% | 0.72 | 106.34 | 2.37 | 161 | 1% |
| 4 | | | | | | |
| Example | 12.02% | 0.75 | 105.65 | 2.36 | 159 | 0% |
| 5 | | | | | | |
| Example | 38.09% | 0.67 | 91.88 | 2.36 | 140 | 0% |
| 6 | | | | | | |
| Example | 38.44% | 0.653 | 116.09 | 2.36 | 177 | 0% |
| 7 | | | | | | |
| Example | 36.29% | 0.69 | 72.34 | 2.36 | 110 | 0% |
| 8 | | | | | | |
| Example | 36.37% | 0.688 | 83.91 | 2.36 | 128 | 0% |
| 9 | | | | | | |
| Example | 36.88% | 0.685 | 98.93 | 2.52 | 159 | 0% |
| 10 | | | | | | |
| Contrast | 55.91% | 0.631 | 105.44 | 2.36 | 159 | 3% |
| Example | | | | | | |
| 1 | | | | | | |
| Contrast | 36.58% | 0.688 | 65.08 | 2.36 | 100 | 0% |
| Example | | | | | | |
| 2 | | | | | | |
| Contrast | 55.82% | 0.632 | 91.90 | 2.36 | 139 | 2% |
| Example | | | | | | |
| 3 | | | | | | |

According to comparison of embodiments and contrast embodiments, the single-side thickness H of the positive electrode film layer is 70-120 μm; based on the total area of the particles in the section in the first region along the thickness direction of the electrode plate, the area proportion of first particles with a particle size R1 meeting R1≥1000 nm is 12-50%; in the cumulative distribution curve of sphericity area of the first particles in the section along the thickness direction of the electrode plate in the first region, the median L_{R1A1}50 of sphericity is 0.6-0.8; when the battery cell is in the full-discharge state and the compacted density of the positive electrode plate is 2.3 g/cm³ to 2.6 g/cm³, the stress concentration between the positive electrode film layer and the current collector is relieved while the battery cell keeps good capacity, the phenomenon that the film layer of the stacked electrode assembly is loosened and even falls off in the die cutting process is relieved, and thus potential safety hazards are reduced.

According to comparison of the Examples 4, 1-3 and 5, based on the total area of the particles in the section in the first region along the thickness direction of the electrode plate, the area proportion of the particles with a particle size R1 meeting 1 μm≤R1≤5 μm is 12-40%, which is conducive to further relieving the stress concentration between the positive electrode film layer and the current collector on the basis of keeping high capacity of the battery, relieving the phenomenon that the film layer of the stacked electrode assembly is loosened and even falls off in the die cutting process, thereby reducing the potential safety hazard.

According to comparison of the Examples 8, 9, 6 and 7, the single-side thickness H of the positive electrode film layer is 90-120 μm, which is conducive to further improving the capacity of the battery.

TABLE 2

| | Positive electrode plate | | | | |
|---|---|---|---|---|---|
| | First region | | | When the battery | |
| | | Median of | | cell is in a full- | |
| | | sphericity of first | Single-side | discharge state, | |
| | Area proportion | particles with | thickness of | the compacted | Number of cycles |
| | of first particles | particle size R1 | positive | density of the | corresponding to |
| | with particle | meeting | electrode | positive | the capacity |
| | size R1 meeting | R1 ≥ 1000 nm | film layer | electrode plate | attenuated to |
| | R1 ≥ 1000 nm | L_{R1A150} | μm | g/cm³ | 90%/cycles |
| Example | 36.64% | 0.687 | 105.64 | 2.36 | 1009 |
| 1 | | | | | |
| Example | 34.78% | 0.673 | 105.89 | 2.36 | 1064 |
| 2 | | | | | |
| Example | 34.95% | 0.745 | 106.21 | 2.37 | 1097 |
| 3 | | | | | |
| Example | 49.96% | 0.72 | 106.34 | 2.37 | 967 |
| 4 | | | | | |
| Example | 12.02% | 0.75 | 105.65 | 2.36 | 1059 |
| 5 | | | | | |
| Example | 38.09% | 0.67 | 91.88 | 2.36 | 957 |
| 6 | | | | | |
| Example | 38.44% | 0.653 | 116.09 | 2.36 | 939 |
| 7 | | | | | |
| Example | 36.29% | 0.69 | 72.34 | 2.36 | 1067 |
| 8 | | | | | |
| Example | 36.37% | 0.688 | 83.91 | 2.36 | 1045 |
| 9 | | | | | |
| Example | 36.88% | 0.685 | 98.93 | 2.52 | 990 |
| 10 | | | | | |

According to the comparison of the Example 7 and the Examples 1-6 and 8-10, in the cumulative distribution curve of sphericity area of the particles with the particle size R1 meeting 1 μm≤R1≤5 μm in the section along the thickness direction of the electrode plate in the first region, the median L_{R1A2}50 of sphericity is 0.67-0.75, which is conducive to relieving the phenomenon that the film layer of the stacked electrode assembly loosens and even falls off in the die cutting process, relieving stress concentration caused by large particles, and improving the cycle performance of the battery.

TABLE 3

| | | Total area | | | Number of cycles |
|---|---|---|---|---|---|
| | | proportion of | Aluminum | | corresponding to |
| | Type and mass | agglomeration | leakage ratio | Capacity | the capacity |
| | content of | region of conductive | after electrode | of battery | attenuated to |
| | dispersant | agent | plate cutting | cell Ah | 90%/cycles |
| Example | 1.1% | 1.99% | 0% | 160 | 1009 |
| 1 | hydrogenated | | | | |
| | nitrile rubber | | | | |
| | (HNBR) | | | | |
| Example | No dispersant | 5.82% | 0% | 160 | 908 |
| 11 | | | | | |

According to the comparison of the Example 1 and the Example 11, based on the total area of the section of the positive electrode film layer in the thickness direction of the electrode plate, the area proportion of the agglomeration area of the conductive agent is 1.5%-5%, which is conducive to reducing the problems of local polarization and even lithium precipitation of the battery in the cycle process, thereby prolonging the cycle life of the battery.

It is be noted that the present application is not limited to the above embodiments. The above embodiments are only examples, and embodiments that have the same composition and exert the same effect as the technical ideas within the scope of the technical solution of the present application are included in the technical scope of the present application. In addition, other methods that apply various deformations that can be conceived by those skilled in the art to the examples and construct them by combining some of the constituent elements of the embodiments are also included in the scope of the present application, within the scope of the application that do not deviate from the main purpose of the present application.

1. A battery cell, comprising: a stacked electrode assembly, wherein the stacked electrode assembly comprises a positive electrode plate, and a negative electrode plate; the positive electrode plate comprises a positive electrode current collector, and a positive electrode film layer disposed on at least one side of the positive electrode current collector; the positive electrode film layer comprises lithium-containing transition metal phosphate particles; at least part of a surface of the lithium-containing transition metal phosphate particles are provided with a carbon material;
a single-side thickness of the positive electrode film layer is recorded as H, and His 70-120 μm; the positive electrode film layer comprises a first region located at a bottom, close to the positive electrode current collector, of the positive electrode film layer; based on a total area of particles in a section along a thickness direction of the positive electrode plate in the first region, an area proportion of first particles with a particle size R1 meeting R1≥1000 nm is 12%-50%, an area proportion of the particles with a particle size R1 meeting 1 μm≤R1≤5 μm is 12%-40%;
in a cumulative distribution curve of sphericity area of the first particles with a particle size R1 meeting R1≥1000 nm in the section along the thickness direction of the positive electrode plate in the first region, a median L_{R1A1}50 of sphericity is 0.6-0.8; and
when the battery cell is in a full-discharge state, a compacted density of the positive electrode plate is 2.3 g/cm³ to 2.6 g/cm³.

2. The battery cell according to claim 1, wherein the single-side thickness of the positive electrode film layer is recorded as H, and His 90-120 μm.

3. The battery cell according to claim 1, wherein the single-side thickness of the positive electrode film layer is recorded as H, and His 100-120 μm.

4. The battery cell according to claim 1, wherein the positive electrode film layer also comprises a conductive agent; and based on the total area of the section of the positive electrode plate in the thickness direction of the positive electrode film layer, the total area of an agglomeration region of the conductive agent accounts for 0.2%-6%, wherein
the conductive agent comprises carbon nanotubes which comprise one or more of a single-walled carbon nanotube, a few-walled carbon nanotube and a multi-walled carbon nanotube; and/or
the agglomeration region of the conductive agent comprises carbon nanotubes and conductive carbon black, wherein based on a mass of the positive electrode film layer, a mass content C1 of the carbon nanotubes meets: 0<C132.5%, and a mass content C2 of the conductive carbon black meets: 0<C2≤2.5%.

5. The battery cell according to claim 1, wherein the positive electrode film layer also comprises a dispersant which comprises hydrogenated nitrile butadiene rubber (HNBR), wherein a mass content of the dispersant is 0.5%-2% based on a total mass of the positive electrode film layer.

6. The battery cell according to claim 1, wherein lithium-containing transition metal phosphate particles in the positive electrode film layer comprise components shown in the following general formula:
LiₘFeₓP_{y}OⱼQ_{q} Formula I,
in which, Q comprises one or more of Al, Na, K, Mg, Cu, Mn, Cr, Zn, Pb, Ca, Co, Ni, Sr, Nb, V, Ti, B, S, Si, N, F, Cl, and Br, 0.8≤m≤1.15, 0.9≤x≤1, 0.95≤y≤1, 3.5≤j≤4, and 0≤q≤0.1.

7. The battery cell according to claim 1, wherein the lithium-containing transition metal phosphate particles comprise a titanium element; and based on a total mass of the lithium-containing transition metal phosphate particles in the positive electrode film layer, a mass content of the titanium element is 500-8,000 ppm.

8. The battery cell according to claim 1, wherein the lithium-containing transition metal phosphate particles comprise a vanadium element; and based on a total mass of the lithium-containing transition metal phosphate particles in the positive electrode film layer, a mass content of the vanadium element is 500-5,000 ppm.

9. The battery cell according to claim 1, wherein the battery cell also comprises a separator arranged between the positive electrode plate and the negative electrode plate; the separator comprises a base film, ceramic layers disposed on two sides of the base film, and a binding layer which is disposed on the side, far away from the base film, of the ceramic layer on at least one side; and the binding layer is a continuous layer of a porous structure and comprises a vinylidene fluoride polymer.

10. The battery cell according to claim 1, wherein the battery cell comprises an electrolyte which meets at least one of the following conditions:
(1) the electrolyte comprises a solvent; and the solvent comprises one or two of Ethyl Methyl Carbonate (EMC) and Ethylene Carbonate (EC), and dimethyl carbonate (DMC);
(2) a mass proportion of the DMC is 18%-32% based on a total mass of the electrolyte;
(3) a total mass proportion of the EMC and the EC is 52%-71% based on the total mass of the electrolyte; and
(4) the electrolyte comprises an electrolyte salt which comprises lithium hexafluorophosphate (LiPF₆), and a concentration of the lithium hexafluorophosphate in the electrolyte is 0.9-1.2 mol/L.

11. (canceled)

12. The battery cell according to claim 1, wherein in the cumulative distribution curve of sphericity area with the particle size R1 meeting 1 μm≤R1≤5 μm in the section along the thickness direction of the positive electrode plate in the first region, the median L_{R1A2}50 of sphericity is 0.65-0.75.

13. The battery cell according to claim 1, wherein in a cumulative distribution curve of C value of degree of graphitization of the positive electrode film layer obtained in a surface scanning mode of a laser microscopic confocal Raman spectrometer, a median C₅₀ of the degree of graphitization is greater than or equal to 0.95 and less than or equal to 1.20, in which, the C value of the degree of graphitization is I_{G}/I_{D}, I_{G} indicates an intensity of a G band of a Raman spectrum at 1580±100 cm⁻¹, and I_{D} indicates the intensity of a D band of the Raman spectrum at 1350±100 cm⁻¹.

14. The battery cell according to claim 1, wherein a porosity of the positive electrode film layer is 14%-28%.

15. The battery cell according to claim 1, wherein a primer is arranged in a bottom region, close to the positive electrode current collector, of the positive electrode film layer, and the primer meets at least one of the following conditions:
(1) the primer comprises a conductive agent and a binder, in which, the conductive agent comprises carbon nanotubes and conductive carbon black, and the binder comprises a vinylidene fluoride polymer; and
(2) a thickness of the primer is 0.5 μm-5 μm.

16. The battery cell according to claim 1, wherein the battery cell comprises a case in which the stacked electrode assembly is accommodated; a size of the case in a length direction is L0, the size of the case in a width direction is W0, the size of the case in a thickness direction is H0, and 450 mm≤L0≤1300 mm, 100 mm≤W0≤150 mm, 14 mm≤H0≤22 mm, wherein
a size L0 of the case in the length direction meets: 450 mm≤L0≤650 mm; and/or
the size L0 of the case in the length direction meets: 900 mm≤L0≤1300 mm.

17. The battery cell according to claim 16, wherein the case meets at least one of the following conditions:
(1) a material of the case is a pouch material which comprises an aluminum-plastic composite film, Polybutylene terephthalate (PBT), Polybutylene succinate (PBS), nylon, Polyethylene terephthalate (PET) and Polyethylene (PE), and aluminum;
(2) the case comprises a first sealing region which is disposed on at least one end, extending along the width direction, of the stacked electrode assembly; the first sealing region comprises an edge folding structure extending along the length direction; and a package adhesive is disposed on the edge folding structure, is continuously arranged along the length direction and is used for fixing the edge folding structure; and
(3) the case comprises at least one second sealing region which is disposed on at least one end, extending along the length direction of the case, of the stacked electrode assembly; and the at least one second sealing region is arranged at a tab side of the stacked electrode assembly.

18. (canceled)

19. The battery cell according to claim 1, wherein at 25 °C, a capacity of the battery cell is 100-300 Ah.

20. A battery apparatus, comprising the battery cell according to claim 1.

21. An energy storage apparatus, comprising the battery apparatus according to claim 20, wherein the battery apparatus is configured to store electric energy.

22. A battery cell, comprising a stacked electrode assembly, wherein the stacked electrode assembly comprises a positive electrode plate and a negative electrode plate; the positive electrode plate comprises a positive electrode current collector and a positive electrode film layer disposed on at least one side of the positive electrode current collector; the positive electrode film layer comprises lithium-containing transition metal phosphate particles; at least part of a surface of the lithium-containing transition metal phosphate particles are provided with a carbon material;
a single-side thickness of the positive electrode film layer is recorded as H, and His 70-120 μm; the positive electrode film layer comprises a first region located at a bottom, close to the positive electrode current collector, of the positive electrode film layer; based on a total area of particles in a section along a thickness direction of the positive electrode plate in the first region, an area proportion of first particles with a particle size R1 meeting R1≥1000 nm is 12%-50%;
in a cumulative distribution curve of sphericity area of the first particles with a particle size R1 meeting R1≥1000 nm in the section along the thickness direction of the positive electrode plate in the first region, a median L_{R1A1}50 of sphericity is 0.6-0.8;
in a cumulative distribution curve of C value of degree of graphitization of the positive electrode film layer obtained in a surface scanning mode of a laser microscopic confocal Raman spectrometer, a median C₅₀ of the degree of graphitization is greater than or equal to 0.95 and less than or equal to 1.20, in which, the C value of the degree of graphitization is I_{G}/I_{D}, I_{G} indicates an intensity of a G band of a Raman spectrum at 1580±100 cm⁻¹, and I_{D} indicates the intensity of a D band of the Raman spectrum at 1350±100 cm⁻¹;
when the battery cell is in a full-discharge state, a compacted density of the positive electrode plate is 2.3 g/cm³ to 2.6 g/cm³.
